(19) United States
(12) Patent Application Publication
(10) Pub. No.: US 2005/0144119 A1
(43) Pub. Date: Jun. 30, 2005

(54) Financing structure

(75) Inventors: Gordon L. Monsen, Riegelsville, PA (US); Joseph C. Yiu, Fort Lee, NJ (US)

Correspondence Address: WILLKIE FARR & GALLAGHER LLP;INTELLECTUAL PROPERTY LEGAL ASSISTANTS, 787 SEVENTH AVE, NEW YORK, NY, 10019-6099, US

(73) Assignee: The Norseman Group, LLC, Parsippany, NJ (US)

(21) Appl. No.: 11/063,064

(22) Filed: Feb. 22, 2005

Related U.S. Application Data
(63) Continuation-in-part of application No. PCT/US04/08361, filed on Mar. 19, 2004.
(60) Provisional application No. 60/455,754, filed on Mar. 19, 2003.

(51) Int. Cl. G06F 17/60

(52) U.S. Cl. 705/38; 705/40

(57) ABSTRACT

A junior loan made by a junior lender to an owner/lessor of commercial real estate that is leased from the owner to a tenant. Ownership of the real estate and the lease may be arranged in one or more special-purpose entities (SPE's) bankruptcy remote from obligations unrelated to the real estate. The junior loan may be secured by the lease rent payments. The lease may be a bond-type lease, or the lease may be enhanced by one or more financial instruments to provide a bond-equivalent guarantee of payment. The junior loan may be collateralized at least in part by (a) a junior assignment of lease rents, or (b) a pledge of the ownership interests of the owner of the real estate. The junior loan may be otherwise non-recourse against the real estate, the owner, or a tenant of the real estate except at most bad boy acts and force majeur events. The owner SPE may surrender to a lockbox arrangement the right to lease rents. The lockbox will make the senior loan payment and the junior loan payment before the owner receives any residual of the rents. An interest rate of the junior loan is based on the credit of the tenant.

### BACKGROUND

This application is a continuation-in-part of International Application Ser. No. PCT\U.S.2004/008361, filed Mar. 19, 2004 and U.S. Provisional Application Ser. No. 60/455,754, filed Mar. 19, 2003, both of which are incorporated herein by reference.

This invention relates to financial structures for commercial loans and leases.

Financial assets, including loans, originate and trade at prices that are negotiated between buyer and seller based on various analyses and intuitions. One important factor in this price may include a “rating” by one or more the three principal credit rating agencies, Standard & Poor's, Moody's Investors Service, or Fitch Ratings Inc. The rating agencies assess the “timely and ultimate repayment of principal and interest.” Generally, before it issues a rating, a rating agency will require that ultimate repayment of principal be established with certainty. A credit rating allows buyers and sellers to compare the asset in question with other similarly-rated assets. In contrast, for unrated assets, there is seldom any common and objective standard for assessing and communicating value, and the perceived value may vary greatly from buyer to buyer. The price a buyer will be willing to pay for an unrated asset will almost always be lower (and thus, the interest rate will be higher), because of the uncertainty associated with the valuation process—the buyer must factor in the risk that, if/when the asset is sold, other buyers may assign a lower value.

In secondary loans on owner-occupied residential real estate (e.g., “home equity loans” or “secondary mortgages”), the secondary lender obtains a right to foreclose on the real estate, subject to a senior lender's right to first payment out of the proceeds of any foreclosure.

In contrast, secondary or subordinate lending to owners of commercial real estate is relatively rare. Subordinate loans (also known as “mezzanine loans” or “junior loans”) typically require a complex inter-creditor agreement between the senior lender, the junior lender, the lessor, and the tenant. A typical inter-creditor agreement reduces the senior lender's right to foreclose and take over the property until the mezzanine lender has had the opportunity to cure a default by the tenant, or may either allow or obligate the mezzanine lender to operate the property. If any one of these parties finds that his position is worsened by the proposed agreement, he has the power to block the entire deal. Similarly, an inter-creditor agreement may leave the junior lender with too many obligations or an insufficient collateral position. For example, in order to lend, a junior lender might require a lien on the property. In this case, the senior lender typically observes that the lien reduces his collateral position, and he blocks the deal. Where junior lenders cannot secure high certainty of repayment, junior lenders charge high interest rates.

Consequently, owners of commercial real estate have had limited ability to borrow against their real estate or the equity that they may have in the real estate. Generally, mezzanine lending rates range from 12-13% where the aggregate capitalization is below 80% to more than 20% where these levels exceed 90%.

### SUMMARY

In general, in a first aspect, the invention features a financing structure. An owner of commercial real estate obtains a senior financing from a senior lender, and a junior loan from a junior lender. Ownership of the real estate and of a lease of the real estate are arranged in one or more special-purpose entities bankruptcy remote from obligations unrelated to the real estate. The junior loan is independent of the senior financing. The owner surrenders over to a lockbox arrangement the right to rents paid by a tenant under the lease. The lockbox is obligated to make a senior payment to the senior lender and a junior payment to the junior lender before the owner receives any residual of the lease payments. The lockbox is structured to isolate payment risk to the credit of the tenant, and a pricing of the junior loan is based on the credit of the tenant.

In general, in a second aspect, the invention features a financing structure. A loan is made by a lender to an owner of an asset, such as commercial real estate. The asset is under lease from the owner to a tenant. The principal of the loan is guaranteed by a credit default swap or other financial derivative arranged to cover default of the tenant on rents under the lease.

In general, in third aspect, the invention features a financing structure. A lender lends funds to create a junior loan from a lender to an owner of real estate, the real estate being under lease from the owner to a tenant. The junior loan is subordinate to a senior loan owed by the owner. An interest rate of the junior loan is based on the credit of the tenant.

In general, in fourth aspect, the invention features a financing structure. An owner of an asset, such as commercial real estate, obtains a senior financing from a senior lender, and a junior loan from a junior lender. The junior loan is secured by payments under a lease of the asset, either the lease providing a bond-type guarantee of payment of rents under the lease, or the lease being enhanced with a bond-equivalent financial guarantee of payment. Ownership of the asset and of the lease are arranged in one or more special-purpose entities (SPE's) bankruptcy remote from obligations unrelated to the asset. A term of the junior loan is no longer than the term of the lease and no longer than the term of a senior financing of the asset. The owner SPE surrenders over to a lockbox arrangement the right to rents paid by a lessee under the lease. The lockbox is obligated to make a senior payment to the senior lender and a junior payment to the junior lender before the owner SPE receives any residual of the lease payments.

In general, in a fifth aspect, the invention features a financing structure. A junior loan and senior loan are made to an owner of commercial real estate. The junior loan is independent of the senior loan. The junior loan is collateralized at least in part by a junior assignment of rents under the lease in lieu of a mortgage foreclosable by the junior lender against the real estate. The junior assignment of rents is junior to any senior mortgage or assignment of rents to the senior lender.

In general, in a sixth aspect, the invention features a financing structure. A junior loan is made by a junior lender to an owner of commercial real estate. The owner of the real estate and of a lease of the real estate surrender over to a cash management (“lockbox”) arrangement the right to rents paid under the lease. The servicer is obligated to make a senior payment to a senior lender and a junior payment to the junior lender from the lockbox before the owner receives any residual of the lease payments. The junior loan is collateralized by a pledge to the lender of rent cash flows generated by a lease of the real estate, and neither a pledge nor a lien over the real estate nor against any ownership interest in any entity with an ownership interest in the real estate, except at most in the event of bad boy acts and force majeur events.

In general, in a seventh aspect, the invention features a financing structure. A junior loan from a lender to an owner of an interest in real estate is subordinate to a senior financing of the real estate. The junior loan is collateralized by a pledge to the lender of rent cash flows generated by a lease of the partnership interest in the entity that owns the real estate. The terms of the junior loan are non-recourse against the real estate, the lessor of the lease, or a tenant of the real estate, except at most in the event of bad boy acts and force majeur events.

In general, in an eighth aspect, the invention features a financing structure. A junior loan from a junior lender to an owner of an interest in real estate has a payment priority that is senior to all other obligations of the owner except a senior loan. The junior loan is collateralized by a pledge to the junior lender of rent cash flows generated by a lease of the real estate. The junior loan is non-recourse against the real estate, the owner, or a tenant of the real estate except at most bad boy acts and force majeur events.

Embodiments of the invention may include one or more of the following features. At least one step of originating, managing or servicing the loan may be performed with the assistance of a computer. Under the terms of the junior loan, in the event of default by the tenant, the owner may covenant to surrender rents under any replacement lease to the lockbox arrangement. The cash management arrangement may include two different servicers or custodians of different depository accounts for servicing the junior and senior loans, respectively. Alternatively, a single servicer may make the payments to the senior and junior lenders from a single depository account. The lockbox arrangement may be under control of a cash management special purpose entity with powers to collect rent and distribute proceeds to the senior and junior lenders. The lockbox arrangement may make a payment for operating expenses or taxes before the owner receives any residual of the lease payments. The independence of the junior loan from the senior financing being due, at least in part, to independence of the junior lender from the senior lender, or due to origination of the junior loan underneath a pre-existing senior financing, with at most minimal reformation of the terms of or re-underwriting of the senior financing. The junior loan may be entered under an existing senior loan, or may be entered contemporaneously with the senior loan. Terms of the junior loan may have the effect of imposing requirements on the tenant in event the tenant enters bankruptcy and reaffirms the lease. The lease may be a bond-type lease, a triple-net lease, a double-net lease, a single-net lease, or a gross lease. A bond-type lease may obligate the tenant to continue to pay rent in the case of at least a partial condemnation taking. Terms of the loan may provide recovery to the junior lender against any recovery by tenant or landlord for the condemnation. A net lease or gross lease may be supplemented with one or more financial products to cover any uncertainty in timely payment of rents by the tenant, to provide the junior lender with certainty of payment equivalent to that provided by a bond-type lease. For example, tenant default may be covered by a put, short, credit default swap, insurance, or other protection. Conditions that may relieve the tenant of an obligation to pay rent may be covered by insurance, or a covenant by a third party to advance expenses required to relieve the condition, which may in turn secured by a cash reserve. The cash reserve may be funded by a premium on the interest rate paid by the landlord, and may be the property of the junior lender, to revert to the junior lender on full repayment of the junior loan. At least part of the junior payment may be reserved in an over-collateralization account for the protection of the obligations. The lease may be a single-tenant lease, or a lease of a multi-tenant property. In cases involving a multi-tenant property, the owner may surrender over to the lockbox arrangement the right to rents paid by several tenants of the real estate. The junior lender may issue obligations backed by the payments from the lockbox arrangement. The obligations may include a private placement participating or syndicating the loan. The obligations may include a publicly-issued security.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

FIG. 1 is an entity cash-flow diagram.

FIG. 2, comprising FIGS. 2a-2e, is a term sheet for an example Mezzanine Loan.

FIG. 3 is a table comparing properties of two capitalization structures.

FIG. 4 is a graph plotting cash flows against time.

FIG. 5 is a flow chart.

### TABLE OF CONTENTS

I. Overview

II. Mezzanine Loan Structure

II.A. Legal Structure—Overview

II.B. Senior Loan 112

II.C. The Lease
II.C.1. “Hell or High Water” Payment Guarantee
   II.C.1(a) Bond-Type Lease
   II.C.1(b) Synthesizing a Bond-Type Lease Using Hedging Structures or Lease Enhancement Insurance
   II.C.1(c) Condemnation
   II.C.1(d) Casualty
   II.C.1(e) Lease Enhancement Insurance
II.C.2. Loan Tenor

II.D. Parties
II.D.1. Borrower/Landlord 130
   II.D.2. Cash Management Lockbox

II.E. Agreements

II.F. Collateral

II.G. Rating

II.H. Pricing and Fee Structures

III. Alternatives

III.A. Interest-Only Variant

III.B. Bonding, Syndicating, or Securitizing the Loan to Investors

III.C. Mating Mezzanine Financing to Senior Financing

III.D. Multi-Tenant Leases

III.E. Financing Secured by Leases of Other Assets

IV. Further Reducing Risk to Investors

IV.A. Hedging Strategies
IV.A.1. Credit Default Swaps
IV.A.2. Hedging Using Other Derivatives

IV.B. Over-Collateralization Account

IV.C. Borrower's Liability Survives Default or Bankruptcy of Tenant

IV.D. Obligations of Tenant on Reaffirmation of Lease in Bankruptcy

IV.E. Full Recourse Due and Payable in Some Events

IV.F. Limitation on Borrower Incurring Debt or Disposing of the Property

IV.G. Required Reserves

V. Reaffirmation Database

VI. Increased Opportunities for Structuring Financing

VII. Investor Valuation of Mezzanine Bonds

VII.A. Loan Pricing Arbitrage

VII.B. Valuation of Bonds Issued by a Mezzanine Structure

VII.C. Subordinate, But Really Pari-Passu

VII.D. Evaluating Credit Default Risk
VII.D.1. Reaffirmation of Leases in Event of Bankruptcy
VII.D.2. Re-Letting Vacated Space
VII.D.3. Default
VII.D.4. Loss Severity
VII.D.5. Recovery
   VIII. Uses
   IX. Computer Implementation

### DESCRIPTION

I. Overview

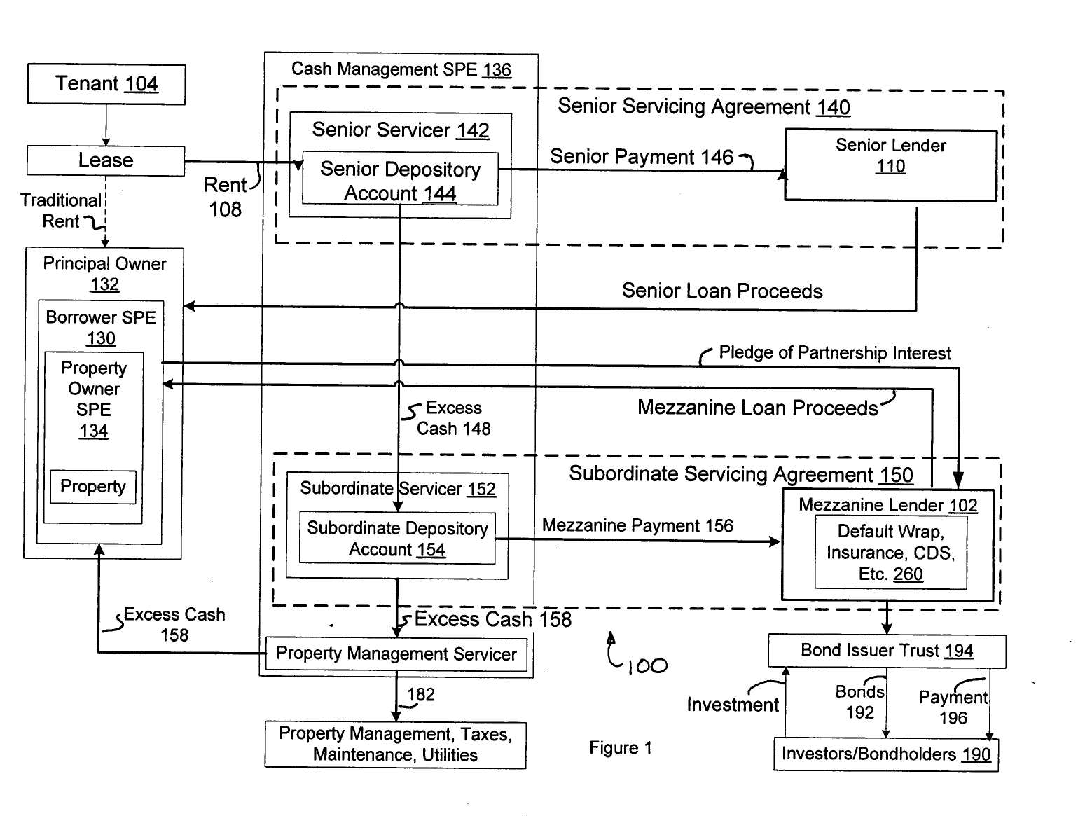

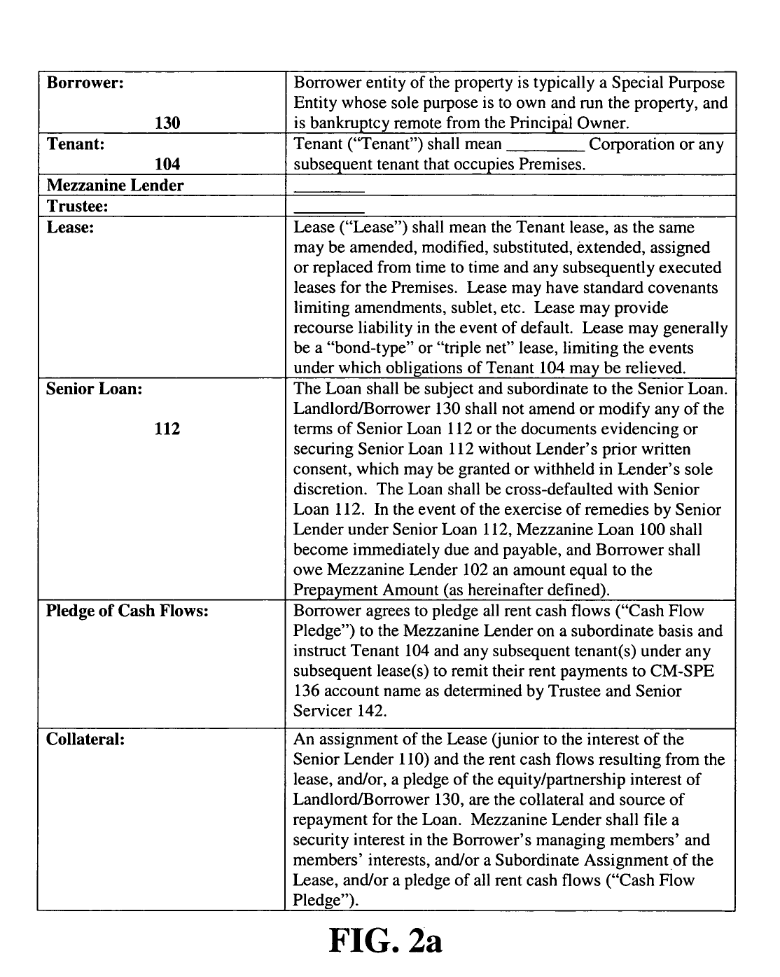

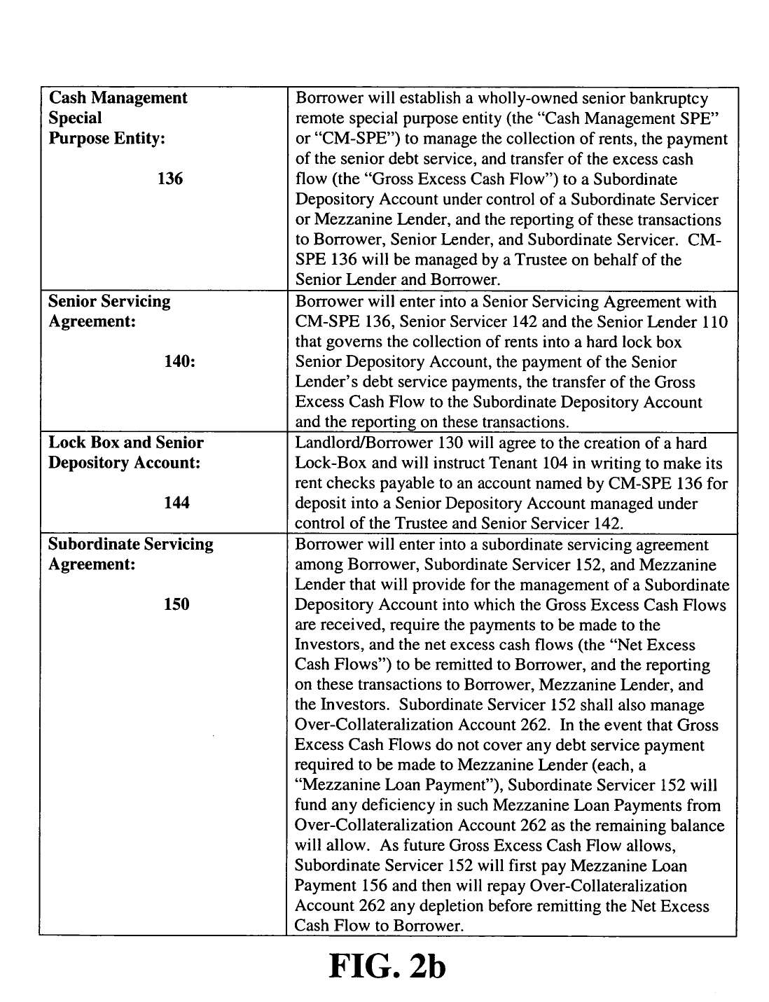

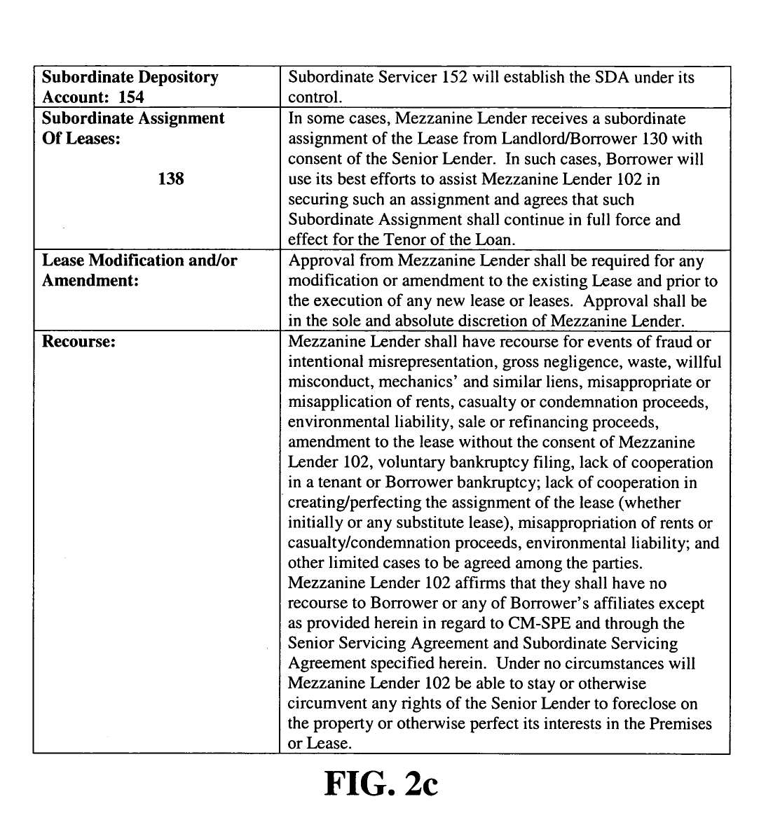

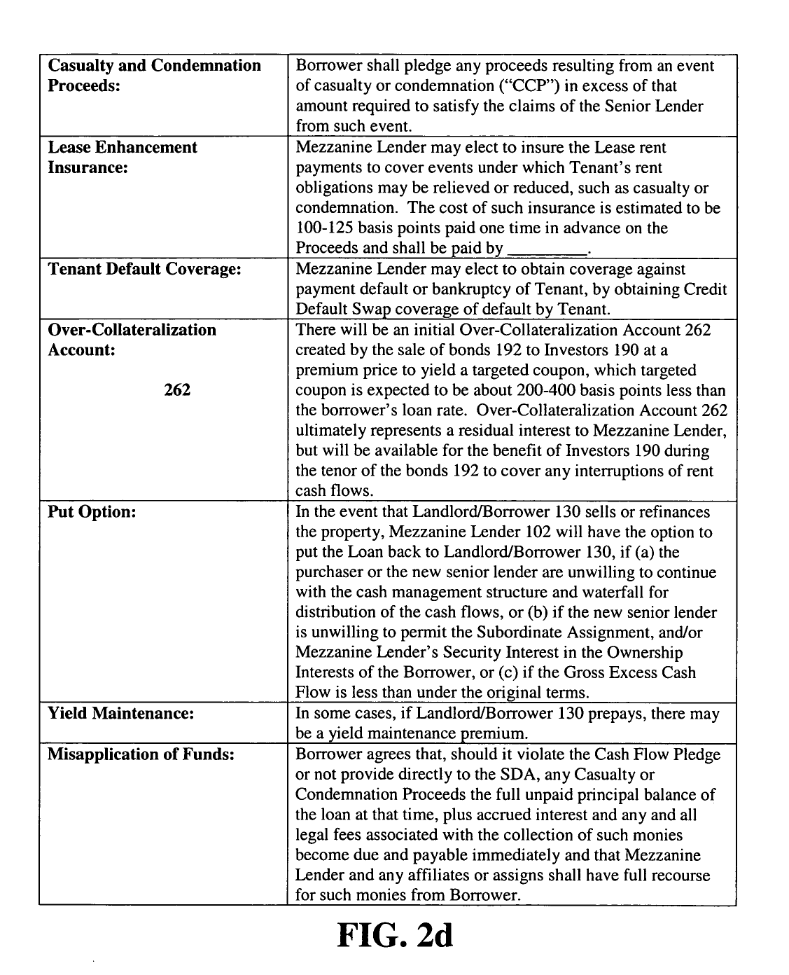

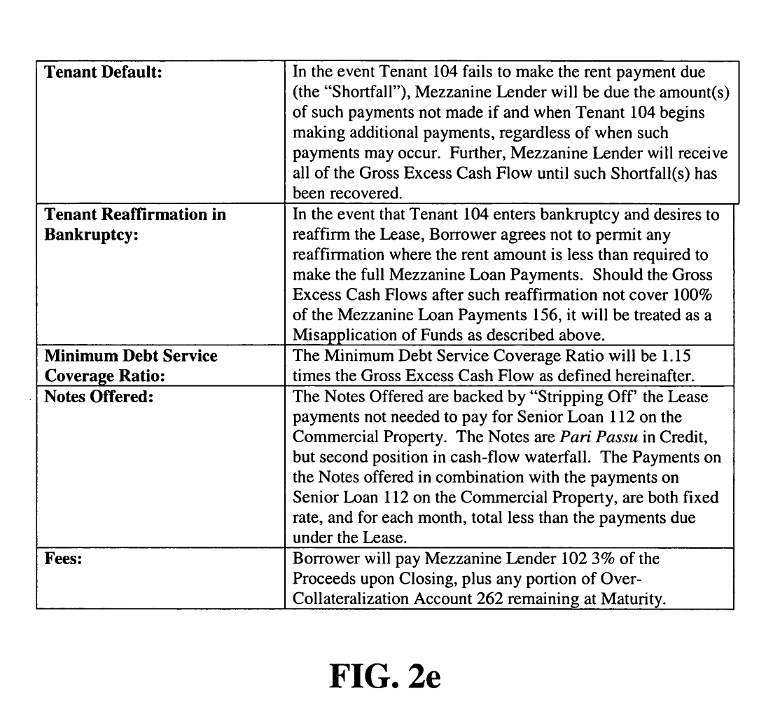

Referring to FIGS. 1 and 2, Mezzanine Loan 100 may be a mezzanine loan made to Owner/Landlord/Borrower 130, 132, 134 of commercial real estate leased to Tenant 104. Mezzanine Loan 100 may be rated by one or more of the three principal U.S. rating agencies at or near the credit rating of Tenant 104. For example, Mezzanine Loan structure 100 may be rated where it is structured to isolate risks relating to the borrower's credit and the real estate itself, and confine repayment risk to the credit of Tenant 104. Especially when it is rated, Mezzanine Loan 100 may will bear an interest rate below the rate for a traditional, unrated mezzanine loan at or near the interest rate of the Tenant's corporate borrowings, and may have enhanced liquidity in the secondary market, and attractive to investors.

The parties to a Mezzanine Loan 100 structure may include Landlord/Borrower 130, Tenant 104, a cash management special purpose entity (CM-SPE) 136, Senior Lender 110, Mezzanine Lender 102, and one or more servicers 142, 152. Ownership of the property may be lodged in one or more special purpose entities 130, 134 that may be created for the sole purpose of owning and managing the property and being obligors on various loans, bankruptcy remote from Principal Owner 132. Principal Owner 132, in turn, is typically a partnership or other entity that has beneficial ownership of the real estate. Landlord/Borrower 130 receives the proceeds of the Loan 100, and assumes the repayment obligation on both Senior Loan 112 and the junior Mezzanine Loan 100. Landlord/Borrower 130 and Principal Owner 132 may irrevocably instruct Tenant 104 to make payment of rent to Senior Depository Account 144. CM-SPE 136 and/or, or with the assistance of, Servicer 142, 152 maintains one or more Depository Accounts 144, 154, and agrees with Senior Lender 110 and Mezzanine Lender 102 to pay Senior Lender 110 first, then Mezzanine Lender 102, in some alternatives, all operating expenses, and then—only out of the residual—Landlord/Borrower 130. The payments flow through the structure in a waterfall of priorities, with each party being paid in order of its priority claim, and the cash flows are isolated from any other interested party except to the extent each party is entitled. The position of Mezzanine Lender 102 may be secured by an assignment 138 of all rents 108 from the leases (typically junior to a first assignment to Senior Lender 110), and/or an assignment of a “soft second” pledge of the partnership interest of Landlord/Borrower 130, to CM-SPE 136 or to Mezzanine Lender 102.

Mezzanine Loan 100 may improve the positions and economics of all of the transaction participants. Because Mezzanine Lender 102 has a payment priority senior to that of Landlord/Borrower 130 and Principal Owner 132, Mezzanine Lender 102 has a sufficient collateral position and limited risk. Mezzanine Loan 100 may be originated in the primary market at a lower interest rate and then subsequently traded between institutions at a higher price than other mezzanine loans. Mezzanine Loan 100 may be more attractive to borrowers, since they pay less interest, and more attractive later to secondary market investors, because they can readily trade it as a rated asset. The necessary parties may find it in their interests to enter the Mezzanine Loan agreement. CM-SPE 136 and Servicers 142, 152 may assume duties to intermediate between potentially-conflicting parties, Senior Lender 110 and Mezzanine Lender 102.

Mezzanine Loan structure 100 may isolate the tenant's rent cash flows 108 from risks relating to owners 130, 132, 134, the property, or senior mortgage 112. Owner risks include (a) that Landlord/Borrower 130, Principal Owner 132 or Owner 134 gets into financial trouble and diverts some or all of the rents that should be used to pay the Mezzanine Loan payment 156 to some other purpose, or (b) that Owner 134, acting as property manager, fails to perform one or more of its obligations to Tenant 104 under the lease, which might allow Tenant 104 to terminate the lease, or to withhold some or all of the rents due until Owner 134 satisfies its non-performance. Real estate risks include a drop in property value, a drop in local real estate market, higher vacancies and lower rents, that the property itself is destroyed by some event or is taken by a governmental authority, or that an environmental problem, such as toxic waste, is found on the property. Isolating these risks may permit Mezzanine Loan structure 100 to be ratable by the rating agencies and have a lower interest rate and high liquidity in the secondary market.

In many alternatives, the Mezzanine Loan structure isolates risk to the credit of Tenant 104, and isolates risk relating to the credit of Landlord/Borrower 130, Principal Owner 132, Owner 134, the property's value, the property type, geographic area, market conditions, and other elements of real estate risk. As real estate cash flow risks are more isolated to the credit of Tenant 104, and Mezzanine Lender 102 gains payment priority relative to the typical subordinate lender, the pricing or interest rate for Mezzanine Loan 100 may more closely reflect the credit of Tenant 104, rather than of Landlord/Borrower 130, Principal Owner 132, or Owner 134 or be derived from the perceived long-term value of the property itself. This pricing or interest rate may typically be much better than the typical subordinate loan to a commercial lessor.

II. Mezzanine Loan Structure

A Mezzanine Loan may be generally structured as follows.

II.A. Legal Structure—Overview

In order to qualify a potential borrower, Mezzanine Lender 102 may prefer to offer to lend against leases of investment grade single tenant properties, or to multi-tenant properties, when Tenant(s) 104 is/are of investment grade or have sufficient credit quality in a larger, multi-tenant property that any bonds issued backed by Mezzanine Lender 102 can be tranched and structured to investment-grade blended levels.

The lease underlying a Mezzanine Loan 100 may be a “bond-type” lease, or a triple-net lease or a double-net lease. (These lease forms are discussed in § II.C.1.) That lease typically lets an entire property to a single investment grade tenant of commercial property, for example, office, warehouse or retail facilities. Such lease terms shift operating expenses, taxes, insurance costs and risks associated with owning and operating the property to Tenant 104, so that Landlord/Borrower 130, Principal Owner 132, and Owner 134 have little or no responsibility to pay any operating expenses (see § II.C). In other alternatives, the structure may create reserves against these costs (see, e.g., § IV.G). In either event, these costs may be reserved out of the cash flow waterfall before paying Mezzanine Lender 102 and Investors 190.

A special purpose entity, Borrower 130, may be created to serve as the obligor on Mezzanine Loan 100. Borrower 130 may be wholly owned by Principal Owner 132 and may, in turn, own the special purpose entity with direct ownership of the property, Owner 134. In cases where there is a pre-existing Senior Mortgage 112, typically Owner 134 is the obligor on that Senior Mortgage 112. Mezzanine Lender 102 may require an opinion of counsel that Borrower 130 is non-consolidated with, that is, is bankruptcy remote from, Principal Owner 132. In other cases, there may be other ownership relationships among entities 130, 132, 134, or a single entity may perform the functions for two of the entities described herein.

Referring again to FIGS. 1 and 2, Mezzanine Loan structure 100 may use two agreements 140, 150 that are linked by two Depository Accounts 144, 154. Depository Accounts 144, 154 may be controlled by independent servicers 142, 152. The parties to Senior Agreement 140 may include Landlord/Borrower 130 and/or Principal Owner 132 and/or Owner 134, Senior Lender 110 and a Senior Servicer 142. Senior Agreement 140 may call for rents 108 to be paid into Senior Depository Account 144, from which Senior Servicer 142 pays payment 146 to Senior Lender 110 and passes the remaining cash flow 148 into the Subordinate Servicing Agreement 150. Subordinate Servicing Agreement 150 among Landlord/Borrower 130, Subordinate Servicer 152, and Mezzanine Lender 102 calls for Subordinate Servicer 152 to pay Mezzanine Loan payment 156 to Mezzanine Lender 102 (or to Investors 190 designated by Mezzanine Lender 102) and to remit the net excess cash flows 158 to Landlord/Borrower 130 or Principal Owner 132. These two Servicing Agreements 140, 150 are linked by an obligation of Senior Servicer 142, pursuant to Mezzanine Loan Agreements 140, 150, to remit 100% of the gross excess cash flows 148 directly from Senior Depository Account 144 to the Subordinate Depository Account 154. Because these agreements isolate the cash flow from any non-contractually specified use of the rent from the Tenant 104, Mezzanine Loan 100 may be financed by Investors 190 based on the corporate bond rate of Tenant 104 (rather than the credit of Landlord/Borrower 130, Principal Owner 132 or Owner 134), for example, with a spread to Mezzanine Lender 102.

II.B. Senior Loan 112

A typical loan secured by real estate is underwritten against, and assumed to be repaid by, some combination of the property, the owner, and the tenant. These three broad elements are the criteria that define and represent the creditworthiness of and collateral for a typical real estate loan. More specifically, Senior Loan 112 may be based on the credit quality of Tenant 104, the credit quality of Owner 134 and/or Principal Owner 132, the ability and history of Principal Owner 132 in managing buildings, the strength of the local commercial real estate market in terms of vacancy rates, rent per square foot, the value of the building, and other factors. Based on these, Senior Lender 110 determines the percentage of that value it is willing to loan, over what period of time the loan is to be repaid, and the interest rate that it will charge Owner 134. Senior Lender 110 may file a mortgage against the property. Senior Lender 110 may also obtain contractual guarantees from Landlord/Borrower 130 or Owner 134 as collateral that can be foreclosed upon in the event Owner 134 doesn't repay the loan.

II.C. The Lease

Tenant 104 signs a lease to pay to Landlord/Borrower/Owner 130, 134 a specified rent for a specified period of time. The amount paid may reflect the average “market rents” tenants pay in the geographic area for similar properties, and the design, materials, and condition of the specific property. However, the rents may be well above typical market rents without impact on Mezzanine Loan 100.
II.C.1. “Hell or High Water” Payment Guarantee

To obtain a rating, it is desirable to structure the lease to ensure that lease payments will continue until Mezzanine Loan is repaid, with low risk of termination, and reduced variability in the lease cash flows (Rent 108). Preferably, the lease is a bond-type lease (see § II.C.1(a)), or else various insurance, capital reserves, or other guarantees are entered to provide assurance of timely payment of rents 108 equivalent to a bond-type lease (see §§ II.C.1 and IV).
II.C.1(a) Bond-Type Lease

In a “bond-type” lease, also known as a “hell-or-high-water” lease, the tenant is responsible for all property taxes, insurance, and operating expenses to run the property. The owner has no responsibilities for any economic aspect of the property. Under a “bond-type” lease, the tenant must make its rent payments every period of the lease, even if the building is destroyed, or a government agency takes the property. A “bond-type” lease is essentially equivalent to the tenant's corporate bonds, isolated from owner and real estate risks. The rent on a bond-type lease is generally lower than on other types of leases where the landlord retains more risk.

Bond-type leases arise most commonly in sale-leaseback transactions, where the current owner of a property sells the property to a financing source, and the financing source then leases the property back to the original owner. In such transactions, a bond-type lease may allow better financing, which in turn helps get the sale leaseback transaction done.
II.C.1(b) Synthesizing a Bond-Type Lease Using Hedging Structures or Lease Enhancement Insurance

In the next “tightest” lease form, the “triple net” lease (“NNN” lease), the tenant is responsible for all real estate expenses, including insurance, taxes, and operating expenses. In a “double net” (“NN”) lease the tenant is responsible for two of these three. Under most NNN or NN leases, in the event of casualty or condemnation the tenant may terminate the lease and discontinue paying rent. In some NNN or NN leases, the landlord may be responsible for certain specified expenses. For example, under a typical NN lease, the landlord may be responsible for roof and structure maintenance. Sometimes the landlord's responsibilities are subject to a cap, and expenses above the cap may be the responsibility of the tenant.

A net lease (either NNN or NN) isolates most repayment risks. For example, because the landlord is not responsible for utilities, a net lease isolates cash flows 108 from changes in electricity rates.

Preferably, the lease backing a Mezzanine Loan 100 is at the “tighter” end of the spectrum, with more risks and obligations allocated to Tenant 104 and fewer to Landlord/Borrower/Owner 130, 134. For example, Landlord/Borrower/Owner 130, 134 should ideally have no responsibilities whose breach would permit Tenant 104 to terminate or abate rent.

In the event that Landlord/Borrower/Owner 130, 134 retains some roof and structure obligations, for example under a NN lease, Landlord/Borrower/Owner 130, 134 may be required to post, or otherwise pay periodic payments into, some form of capital reserve, for example, as discussed in § IV.G.

Additional alternatives for guaranteeing timely repayment are discussed in § IV, below.

In cases where a net lease leaves some uncertainty in the timeliness of repayment, the agencies may reduce the rating of the loan below that of Tenant 104. Where these lease-related structural features are successful in securing payment obligations equivalent to a bond-type lease, the ratings agencies may rate Mezzanine Loan 100 at the credit rating of Tenant 104.
II.C.1(c) Condemnation

The government may take private property for public use through condemnation or eminent domain proceedings by paying compensation to the property owners.

Most triple-net or double-net leases obligate Tenant 104 to continue to make payments under the lease in case of a temporary or partial taking that permits the continued use of the property. However, in the case of a total taking or a partial taking that renders the remaining portion of the property unsuitable for its intended use, the lease typically will terminate, and the lease may obligate Tenant 104 to pay an amount sufficient to retire the outstanding debt.

If the government takes a portion of the property that does not render the remaining portion unsuitable for Tenant 104 to terminate the lease, Landlord/Borrower/Owner 130, 132, 134 may be required to apply the condemnation award proceeds to partially prepay the debt and thereafter reduce the lease payments due to an amount sufficient to pay all the future debt service. To the extent Tenant 104 is not obligated under the lease to follow the above procedure, Landlord/Borrower/Owner 130, 132, 134 may provide for insurance to cover the condemnation risk.
II.C.1(d) Casualty

Landlord/Borrower/Owner 130, 132, 134 and/or Tenant 104 may be required to carry casualty insurance, and, in the case of damage or destruction, to apply all insurance proceeds to repairing or rebuilding the property as nearly as practicable to its previous fair market value and utility.

As part of the underlying lease, Tenant 104 may have assumed an obligation that, where the insurance proceeds are insufficient to restore the property, Tenant 104 must complete the restoration at its own expense. If restoration is economically impractical following a substantial casualty, often Tenant 104 may terminate the lease by paying a termination amount or by purchasing the property in an amount at least sufficient to retire the outstanding debt. To the extent Tenant 104 is not obligated for the above, the Landlord/Borrower/Owner 130, 132, 134 may provide insurance to mitigate the casualty risk.

Landlord/Borrower/Owner 130, 132, 134 may irrevocably direct Senior Lender 110 to pay all excess casualty insurance proceeds and condemnation awards above the amount necessary to satisfy the claims of the Senior Lender from such event into the Senior Depository Account 144, for transfer to Subordinate Depository Account 154.
II.C.1(e) Lease Enhancement Insurance

In some alternatives, all responsibility for maintenance of the property, including roof and structure, may be the obligation of Tenant 104. Tenant 104 may have this obligation under the pre-existing lease, or it may be a negotiated modification at the time Mezzanine Loan 100 is originated, or at another time.

In some alternatives, if the existing lease leaves too much risk that Tenant 104 may terminate the lease or abate or reduce rental payments, for example, if Landlord/Borrower/Owner 130, 132, 134 may default on his obligations to maintain the property, then Landlord/Borrower/Owner 130, 132, 134 may be required to negotiate a “tighter” lease with Tenant 104. Alternatively, Landlord/Borrower/Owner 130, 132, 134 may be required to provide a non-cancelable, fully prepaid lease enhancement insurance, casualty and condemnation insurance, or lease interruption insurance policy naming Mezzanine Lender 102 as insured, in an amount sufficient to pay the outstanding principal amount of Mezzanine Loan 100, together with any accrued interest and the present value of the remaining interest payments. Business interruption insurance may also be obtained to cover the rent for twelve months or until other insurance pays. This insurance, available from AIG and/or from International Amalgamated Group (also known as “Fisher Shapiro”), New York, N.Y. (www.afisherco.com), may cost approximately 75-100 basis points as a one-time fee payable upon execution of Mezzanine Loan 100. Such insurance is often required by the senior lender for its own benefit and may already be in place.

In some alternatives, any remaining risk (whether of condemnation, casualty, default of landlord obligations, repairs required by normal wear and age, etc.) may be covered by a capital reserve, for example, as discussed in § IV.G.
II.C.2. Loan Tenor

Mezzanine Loan 100 may be structured to require that full repayment of the loan occur within the shorter of the lease expiration or the mortgage maturity. (A commercial real estate mortgage may have a maturity date before the end of the loan's term or that period over which the loan amortizes to a balance of zero. For example, in a “120/360” loan, the payment amount will amortize the loan over a term of 360 months, but after 120 months, the mortgage matures and the full balance remaining is due as a “bullet” repayment.) Requiring full repayment of Mezzanine Loan 100 by the expiration of the lease reduces the risk that Tenant 104 may not renew the lease, and cease payments before the loan is paid. Similarly, requiring full repayment of Mezzanine Loan 100 by the maturity of the mortgage reduces risk that the financing underneath Mezzanine Loan 100 may be detrimentally disturbed, for example, if Landlord/Borrower/Owner 130, 132, 134 pays off the mortgage by selling the property, refinances the mortgage or, by prepays the mortgage out of the owner's equity.

II.D. Parties
II.D.1. Borrower/Landlord 130

Landlord/Borrower 130 and Owner 134 are typically partnerships, limited liability partnerships, limited liability companies, grantor trusts, or other form of a special purpose entity (“SPE”), chartered solely to own and lease the property, bankruptcy remote from Principal Owner 132, with independent directors. Landlord/Borrower 130 may be structured to isolate the lease cash flow 108 from any business risks of Principal Owner 132 or Owner 134 and any performance risks of Landlord/Borrower/Owner 130, 132, 134 under the lease that would give Tenant 104 any right to abate rent. In some alternatives, Mezzanine Lender 102 may require approval of the charter or partnership documents for Landlord/Borrower 130, for example, to limit Landlord/Borrower 130 from incurring additional debt, and may require proof of adequate capitalization of Landlord/Borrower 130 by Principal Owner 132. Independent of the Mezzanine structure, many commercial properties are typically owned by such special purpose entities, typically pursuant to Senior Loan 112, and the existing charter of that entity may in many cases satisfy the requirements of Mezzanine Lender 102 with little further charter modification.
II.D.2. Cash Management Lockbox

Rents may be isolated from owner risks by implementation of a lock box and cash management account or special purpose entity 136 with a stated cash flow “waterfall” or priority of payments. Landlord/Borrower 130 may irrevocably instruct Tenant 104 to remit all of its rent payments 108 to a “hard lock box” 136, 144, 154. Lock Box 136 may be a bank account under the control of a third party financial entity or may be a special purpose entity under contract. Lock Box 136 may receive the rents 108, distribute them according to a prioritized sequence of payments, and only after all these payments are made, distribute any remaining cash 158 to the Landlord/Borrower 130 or Principal Owner 132. These features may reduce the risk that Landlord/Borrower 130 might withhold part or all of the required Mezzanine Loan payment 156. The priority of payments made—or “waterfall”—usually pays Senior Lender 110 first, then any reserves, then Mezzanine Loan payment 156, and then any balance remaining for Landlord/Borrower 130. If Lock Box 136 already exists pursuant to Senior Loan 112, Mezzanine Loan 100 may piggyback on that structure.

Cash Management Special Purpose Entity (CM-SPE) 136 may be specially created to own the lease for the life of Mezzanine Loan 100, or to manage the lease. CM-SPE 136 may be assigned all rights to Rent 108, and may assume obligations to collect rent 108 from Tenant 104, pay the senior debt payment 146, transfer the gross excess cash flow 148 to Subordinate Depository Account 154, and report on these collection and payment efforts to Landlord/Borrower 130 and Senior Lender 110. However, none of these activities of CM-SPE 136 affect the property itself, because title to the property and all rights relating to the property may remain with Landlord/Borrower 130. CM-SPE 136 may be 100% owned by Landlord/Borrower 130 and/or Principal Owner 132, and bankruptcy remote from Landlord/Borrower 130 and Principal Owner 132. A trustee may be appointed for CM-SPE 136 that is mutually acceptable to Senior Lender 110 and Mezzanine Lender 102. CM-SPE 136 may be chartered to exist for the life of Mezzanine Loan 100 or for the longer of the two debt tenors.

Landlord/Borrower 130 may covenant, represent or warrant to Mezzanine Lender 102 that it will cause all leases currently in effect or that are made in the future to be conveyed and pledged to the CM-SPE 136 and/or to Mezzanine Lender 102 along with a subordinate assignment 138 of the leases and that it will instruct in writing all current and future tenants to make their rent payments directly to Senior Depository Account 144.

II.E. Agreements

Senior Servicing Agreement 140, among Landlord/Borrower 130, CM-SPE 136 (in structures that use such a special purpose entity), Senior Lender 110 and Senior Servicer 142, may require Senior Servicer 142 to collect rents 108, disburse payments 146 on Senior Loan 112 as due to Senior Lender 110, transfer the gross excess cash flows 148 to Subordinate Depository Account 154, and report on these collections and disbursements to the parties to Senior Servicing Agreement 140. Senior Servicing Agreement 140 may also create a hard lock-box arrangement and Senior Depository Account 144.

Subordinate Servicing Agreement 150 may create a Subordinate Depository Account 154 into which all gross excess cash flows 148 after payment 146 of Senior Loan 112 are transferred and deposited. Landlord/Borrower 130 may irrevocably direct the Senior Servicer 142 to cause all such transfers of the gross excess cash flow 148 to Subordinate Depository Account 154. Subordinate Depository Account 154 may be maintained in the name of Subordinate Servicer 152 or Mezzanine Lender 102. Mezzanine Lender 102 may have a perfected security interest in Subordinate Depository Account 154. Subordinate Servicer 152 then disburses payments 156 to Mezzanine Lender 102. Subordinate Servicer 152 then remits any net excess cash flows 158 to Landlord/Borrower 130. Any misallocation of rents by Landlord/Borrower 130, or Principal Owner 132 may give Mezzanine Lender 102 and its beneficiaries and affiliates full recourse to Landlord/Borrower 130, Principal Owner 132 and Owner 134 for the unpaid principal balance of Mezzanine Loan 100.

The parties may agree that the property will be managed by a mutually-agreed property manager 180, with the approval of Mezzanine Lender 102 over fees, terms and scope of services. For any operating expenses that are not required to be paid by Tenant 104, Mezzanine Loan servicing agreements 140, 150 may implement an irrevocable cash flow payment waterfall whereby all operating expenses are paid by servicers 142, 152 prior to Landlord/Borrower 130 or Principal Owner 132 receiving any cash flow. Such operating expenses may be paid out of rents 108 before payment 146 to Senior lender 110, or may be paid out of cash flows 148 before payment 156 to Mezzanine Lender 102, or may be paid out of cash flows 158 after payment 156 of Mezzanine Lender 102.

In some cases, Senior Lender 110 and Mezzanine Lender 102 may enter an intercreditor agreement. For example, such an agreement may expressly provide that Mezzanine Lender makes no claim on the property itself, beyond the pledge of partnership interests in Landlord/Borrower/Owner entities 130, 132, 134. The Intercreditor Agreement typically constrains Mezzanine Lender 102 from interfering with the discretion of the Senior Lender 110 in exercising any and all of its remedies. Senior Lender 110 may agree that, in the event of a non-monetary default (e.g., Landlord/Borrower 130 fails to timely send reports, provide access to books, etc.), Senior Lender 110 will not exercise rights to capture the rent cash flows 108.

The entities and relationships described above are only one example among many possible alternatives. For example, because the contractual obligations of servicers 142, 152 to Senior Lender 110, Mezzanine Lender 102 and to Landlord/Borrower 130 are clear, a single entity may perform several or all roles. Similarly, the Senior and Subordinate Servicer Agreements 140, 150 may be combined into a single agreement. In some alternatives, in view of the conflicts that may arise in the event of default by Tenant 104, it may be desirable to allocate the tasks of paying the two Lenders 110, 102 to two different servicers 142, 152 in priority order, as described above. In other alternatives, it may be desirable to combine these two functions in a single servicer, or to combine Senior Depository Account 144 and Subordinate Depository Account 154 into a single account from which payments 146, 156 and 158 are made. In other alternatives, it may be desirable to split the functions among two entities, one for each half of the overall structure. Servicers 142, 148 may be the same entity or two different entities, and may be a bank or similar trust organization.

II.F. Collateral

In some cases, Mezzanine Loan 100 may be a non-recourse loan, for example, in cases where non-payment by Tenant 104 is covered by a credit default swap 260 or other financial hedge (see § IV.A).

In other alternatives, Mezzanine Lender 102 may have some recourse against Landlord/Borrower 130, Principal Owner 132 or Owner 134, to repay the remaining principal balance in the event of a default by Tenant 104.

In some alternatives, Senior Lender 110 may approve a subordinate assignment 138 of the lease to Mezzanine Lender 102. Mezzanine Lender 102 may have a lien against the lease rent cash flows 108 to CM-SPE 136. In such cases, Tenant(s) 104 will be concurrently irrevocably directed to make rent payments 108 directly to the Senior Depository Account 144.

In other alternatives, Mezzanine Lender 102 may take a pledge of partnership interest in the Landlord/Borrower 130, Principal Owner 132, or Owner 134, but without any lien directly against the real estate. Under a pledge of partnership interest Senior Lender 110 retains the lien against the real estate, while Mezzanine Lender 102 obtains a right of foreclosure against the ownership of Landlord/Borrower/Owner 130, 132, 134. Foreclosure on the pledge of partnership interest results in Mezzanine Lender 102 acquiring ownership of Landlord/Borrower 130, Principal Owner 132 or Owner 134, and thus the property itself, subject to curing any default to Senior Lender 110. Mezzanine Lender 102 may then re-market the property, or else liquidate the property entirely.

In some alternatives, Mezzanine Lender 102 may have a right of foreclosure against the property itself. Foreclosure may relieve the obligation of Landlord/Borrower 130 to Mezzanine Lender 102, subject to Mezzanine Lender 102 assuming all outstanding obligations under Senior Loan 112 to Senior Lender 110.

Generally, the more recourse and better the collateral position Mezzanine Lender has against Landlord/Borrower 130 and the property, the lower the interest rate charged on Mezzanine Loan 100.

Mezzanine Lender 102 may have recourse that mirrors the “bad boy act” provisions and non-monetary defaults of Senior Loan 112.

The Mezzanine Loan agreements, including Senior Servicing Agreement 140, and Subordinate Servicing Agreement 150, may be entered contemporaneously with the origination of Senior Loan 112, or contemporaneously with the entry of the lease between Landlord 130, 132, 134 and Tenant 104, or may be entered later, underneath or behind and subordinate to a pre-existing senior financing 112. Mezzanine Lender 102 may require the usual documentation for a commercial real estate loan, for example, a description of the property, the purchase price, details of the Senior Loan financing 112 (including the tenors and identity of Senior Lender 110), documentation evidencing that Landlord/Borrower 130 owns and controls the property, a copy of the lease between Landlord/Borrower 130 and Tenant 104, appraisals, evidence of compliance with laws and regulations applicable to the property (including, for example, permits, approvals, licensing and zoning), title commitments, surveys, lien searches, property and liability insurance, environmental reports, physical condition reports, credit reports, background check on Principal Owner 132 and Landlord/Borrower 130, and organizational documentation.

The loan may be underwritten based on the senior unsecured credit of Tenant(s) 104 and the underlying SWAPS benchmark rate for the average life of the tenor of the loan, which in turn may be based on the lease tenor. A spread may be added to the coupon appropriate to the senior unsecured borrowing rate of Tenant 104 to make the coupon attractive to buyers of the resulting Mezzanine Loan, plus a premium for prepayment and any additional spread or fees incurred to turn the lease into a bond-type lease, and perhaps a premium to serve as an incentive for an investment bank to fund the loan.

The loan documents may include conditions precedent, affirmative and negative covenants, representations and warranties, and miscellaneous provisions typical to commercial real estate and/or credit tenant financing structures, or tranched bond structures.

II.G. Rating

Traditional mezzanine loans are typically illiquid in the secondary market. In order to sell any mezzanine loan, the seller has to convince a potential buyer that the buyer should be willing to either foreclose on the partnership and thereby own the property, or that there is really no potential for the loan going into default. Foreclosure typically obligates the mezzanine lender to bring the senior mortgage loan debt payments current, maintain those payments current, invest additional capital in fixing up the property, market the space to new tenants and pay leasing brokerage commissions in order to eventually have a profitable property investment, and then keep or sell the property.

Further, in many mezzanine loan deals, the senior lender is concerned with the mezzanine lender “becoming the borrower.” The senior lender underwrote the property and the credit and real estate expertise of the owner/borrower, and may be reluctant to establish a contractual relationship in which, in the event of default, repayment of the senior loan may turn on the real estate management skills of the mezzanine lender.

Mezzanine structure 100 may reduce the likelihood that Mezzanine Lender 102 must foreclose on the pledge of partnership interest and any reduce the likelihood of the mezzanine lender acquiring such obligation.

If Tenant 104 is already rated, payments 196 on Mezzanine Loan may carry the rating of Tenant 104. In some cases, where Tenant 104 is of investment grade but unrated, it may be possible to obtain a “shadow rating” for Mezzanine Loan 100, independent of any rating of Tenant 104 per se. As discussed in §§ VII.C and VII.D below, the rating of Mezzanine Loan 100 may be higher than the rating of Tenant 104, especially where Mezzanine Loan 100 is further enhanced, for example using the techniques described in § IV.

II.H. Pricing and Fee Structures

Interest rates for Mezzanine Loans 100 charged to Landlord/Borrowers 130 may be determined by a variety of pricing structures.

Pricing may be set by credit grade of Tenant 104. For example, a Loan 100 backed by a lease to a AAA-rated tenant may bear a rate of 50-75 basis points over some benchmark, such as the treasury rate, Wall Street Journal prime rate or LIBOR, while AA, A and BBB tenants may bear rates with progressively larger spreads. Fees for lease enhancement insurance, etc. may be borne by Landlord/Borrower 130.

In other alternatives, where Loan 100 is hedged by a credit default swap or other derivative 260 (see § IV.A), interest rate for Mezzanine Loan 100 might be 135 basis points plus the cost of the hedging derivative, such that the sum of the spread components reflects a credit spread appropriate to the credit rating of the tenant.

In other alternatives, the average price for credit default swaps for all companies of a given credit rating class may be averaged, and Mezzanine Loans 100 for all tenants of that class may be priced based on a spread charged relative to that average.

Notes 192 sold by Mezzanine Lender 102 may carry a gross coupon equal to the gross rate 156, with deductions for any hedging premiums (see § IV.A) and any sub-servicing spread retained by Mezzanine Lender 102. Thus, even though all notes may carry the same net coupon reflecting the AAA rating of the credit default swap seller, the net cost of capital to Landlord/Borrower 130 is based on the tenant's cost of funds, because the cost of the credit default swap is based on the credit of Tenant 104.

For example, a Mezzanine Loan 100 against a lease in which Tenant 104 is IBM might be priced as follows: In our example, IBM might be rated A- and have a 5-year CDS of trading at 100 basis points. Mezzanine Lender 102 may then add its fees and profit, which might be 75 basis points. If the underlying treasury benchmark or swap rate is 4.4%, the total rate to Landlord/Borrower 130 is 4.4% (440 basis points)+100 basis points+75 basis points=615 basis points, 6.15%, plus origination fees of, for example, 60 basis points.

III. Alternatives

III.A. Interest-Only Variant

In some cases, Mezzanine Loan 100 may be structured as a fully self-amortizing level-payment loan.

In other cases, Mezzanine Loan 100 may be structured as an interest-only loan for an initial portion of the term, and the remaining term of the loan may use self-amortizing payments. For example, a ten-year loan may have an interest-only first year, under which the lease payments may flow through Servicers 142, 152, and payment 156 to Mezzanine Lender 102 may be limited to interest only, without an amortization of principal. At the end of the year, Landlord/Borrower 130 may have an option to pay the entire principal (this principal will be equal to the initial principal of the loan). If Landlord/Borrower 130 does not exercise this option, then the loan may automatically roll into a self-amortizing nine-year extension term. The payments during this nine-year extension term will, of course, be somewhat higher than the equivalent payments would be under a full ten-year self-amortizing arrangement. Consequently, so that the debt service load during the nine-year extension term does not exceed the underwriting limit that Lender 102 applies to Tenant 104 and the underlying lease, the maximum amount to be lent on these terms will be somewhat lower such that the amount originally loaned as Interest Only is capable of being paid off from the available cash flows in the remaining nine years.

An interest-only arrangement provides a much lower debt service constant for Landlord/Owner/Borrower 130, 132, 134 during the first year. This may be especially attractive in cases where Principal Owner 132 intends to sell the property during that year.

Other payment structures may be agreed by the parties.

III.B. Bonding, Syndicating, or Securitizing the Loan to Investors

Mezzanine Lender 102 may obtain financing from a number of sources.

Mezzanine Lender 102 may obtain a warehouse line from a financing source.

Mezzanine Loans 100 may be sold as whole loans. The secondary market may be reasonably liquid because the expected loss rate on a Mezzanine Loan 100 may be lower than that of a corporate bond, as discussed in § VII.D.

The loan documents may give Mezzanine Lender 102 the right to assign, syndicate, sell, pledge, securitize, or participate all or any portion of a Mezzanine Loan to Investors 190. In some instances, an Issuer Trust 194 may be created by Mezzanine Lender 102 to issue bonds 192, make bond payments 196, and make accounting and reports on the payments and balances. Issuer Trust 194 may be chartered to exist for the longer of the two debt tenors.

Mezzanine Bonds 192 may be issued as asset-backed securitization or collateralized debt obligations (“CDO”). The “asset” that technically serves as the bond collateral is a junior assignment 138 of the leases, a pledge of the partnership interests of Landlord/Borrower 130 (which typically includes ownership of the property owner SPE 134 as a subsidiary thereof). The pricing of bonds 192 may be based on the senior unsecured borrowing spread of Tenant 104 plus a spread to provide an illiquidity premium to cover minor cashflow inconsistencies. The tenors of Mezzanine Bonds 192 may extend for any desired amount of time, to a maximum tenor coterminous with the lease. Ten years may be a typical tenor. For AAA to BB rated tenants, the rate may be about 50-350 basis points above the senior unsecured borrowing rate of Tenant 104.

The debt from the issuance of bonds 192 may be carried on the balance sheet of CM-SPE 136, Mezzanine Lender 104, or Issuer Trust 194.

III.C. Mating Mezzanine Financing to Senior Financing

Mezzanine Loans 100 may be suited to the acquisition of assets, refinancing of assets, or taking out equity by layering mezzanine debt on assets that retain the existing senior debt 112.

In the event that Landlord/Borrower 130 elects a public bond issue for senior financing 112 (for example, in a commercial mortgage-backed securities issue), it may be desirable to use a “hard” or “soft” lockbox structure for the payments, to ensure Mezzanine Lender 102 and Investors 190 that Landlord/Borrower 130 does not have the ability to divert rent cash flows away from the payment priority agreed to in the bond covenants and upon which they had based their investment decisions and financial evaluations. In contrast, where senior financing 112 is a private placement to a single lender (such as a life insurance company), lockbox arrangements may be less common, because of the greater flexibility Senior Lender 110 has to exploit its avenues of recourse. Mezzanine Loan structure 100 can be used with either form of senior financing 112.

III.D. Multi-Tenant Leases

The use of a credit default swap 260 (see § IV.A.1) or other hedge (see § IV.A) may permit a Mezzanine Loan 100 on a property that is leased to multiple tenants. For example, in cases where all tenants are rated, a separate credit default swap can be purchased against each tenant, so that the overall risk becomes that of the seller of the credit default swap. If one or more of the tenants default on their lease(s), the swap counterparty pays off the remaining principal balance of the lease payments, which represents a partial repayment of Mezzanine Loan 100. The remaining tenant or tenants continue to pay the remaining principal balance of the loan out of the rent payments they make.

III.E. Financing Secured by Leases of Other Assets

Mezzanine structure 100 may also be used to finance other types of assets. For example, a lessee 104 may lease an expensive piece of equipment (e.g., airplanes, manufacturing or data processing equipment, etc.). Where lessee 104 has a traded credit default swap, lender 102 may wrap the lease cash flow 108 in a credit default swap and securitize the lease cash flows 108 using lockbox structure 154 and other features described herein to protect the cash flow against default of lessor 104.

IV. Further Reducing Risk to Investors

Even though the Mezzanine Loan structure inherently reduces default frequency and loss severity (see § VI.D), there may still be some risk of default by Tenant 104 and consequent loss.

The default risk of a Mezzanine Loan 100 may be hedged or insured through one or more of several alternative arrangements, even in alternatives where Mezzanine Loan 100 is made with no collateral from the property or ownership interest. Especially in alternatives where Mezzanine Loan 100 is isolated from the property, and collateralized solely by the creditworthiness of Tenant 104, credit derivatives may be used to hedge out much or all of the default risk. These features may give Mezzanine Bonds 192 cash flow ratings comparable to those of a bond-type lease.

IV.A. Hedging Strategies

Financial derivatives may be used to hedge out any perceived residual loss risk during the aggregation and securitization period, particularly where Tenant 104 is an investment grade company, or where Tenant 104 has issued either bonds or publicly traded stock. Such derivatives may function as “surrogate” or “proxy” collateral, drawn from outside the traditional real estate finance paradigm. In some cases, such techniques may allow the rating of Mezzanine Loan 100 to surpass the rating of the tenant itself, and may allow a Mezzanine Loan to be made to the owner of properties leased to more than one rated tenant.
IV.A.1. Credit Default Swaps

In some cases, CM-SPE 136 or Mezzanine Lender 102 may purchase a credit default swap 260 from a swap dealer to cover default by Tenant 104 of rent payments 108. Credit default swaps (“CDS”) 260 are a form of derivative contract in which the seller of the CDS sells protection against a default by a rated entity over a given term to the owner of an asset issued by the entity. Credit default swaps historically involved a swap of one type of risk for another, but have evolved into a custom contract to simply buy protection, much like insurance, against default. CDS's are principally used by investors to protect against default of senior unsecured bond issues of a corporation: a holder of an obligation of the corporation pays a seller of CDS protection a premium, typically monthly, and if the corporation defaults on the repayment of the bond, the seller of CDS protection pays the buyer of protection—and typically the owner of bonds—the principal amount due, often in exchange for the defaulted obligation.

A typical credit default swap contract provides that if Tenant 104 defaults on the lease, CM-SPE 136 provides notice to the swap dealer, and the swap dealer pays the balance of the principal and interest due on the loan. Such swaps are available, for example, from Deutsche Bank. The swap dealer may short bonds or stock to be able to deliver the contracted-for coverage in the event Tenant 104 defaults, and the dealer will manage risks internally to ensure that these shorts are neither overhedged nor underhedged.

Mezzanine Lender 102 may purchase CDS protection 260, either as a lump sum on origination or out of the monthly fees. The CDS seller may agree to pay off Mezzanine Loan 100 (in full or in part), upon default of Tenant 104 upon legal notification of the tenant's default under the lease. Alternatively, the cost of CDS protection may be reduced by mutual agreement between Mezzanine Lender 102 and the Swap Dealer in return for Mezzanine Lender 102 giving Swap Dealer its pledge of partnership interest, some interest in the re-let lease rent, the loan repayment obligation of Landlord/Borrower 130, or some other form of payment to Swap Dealer.

The price of the CDS 260 is based on the credit of Tenant 104, the term of protection, and the amount of coverage. Lower credit tenants, longer terms, and higher amounts and higher coverage-to-loan ratios will each tend to increase the price of a CDS.

The default by a rated tenant on a lease obligation is an event of default that may put the tenant corporation into bankruptcy and trigger the CDS 260 payment (see § VII.D). Any remaining principal balance due will be fully repaid under the terms of its credit default swap contract. Since sellers of CDS protection are most often AAA-rated financial institutions, the risk of the ultimate repayment of Mezzanine Loan 100 becomes the risk of the AAA-rated CDS seller and Mezzanine Loan 100 may be rated at the rating of the seller of the CDS, rather than the rating of Tenant 104. This may allow Mezzanine Lender 102 to reduce the interest rate it charges even further (subject to payment of the CDS premium at origination) and may improve the liquidity of the asset in the secondary market.
IV.A.2. Hedging Using Other Derivatives

In other cases, a Mezzanine Loan 100 may be hedged, for example, as follows. Consider an example Loan 100 collateralized by a lease with nine years' remaining tenor. The risk to the principal may be hedged by buying put options on debt or equity securities of Tenant 104, one put corresponding to each year remaining in the tenor of the Loan 100. Each put option allows Mezzanine Lender 102 to tender securities to a counterparty, and demand payment at an agreed exercise price, even if the current market price of the securities is above the agreed exercise price.

Each put covers securities that, at the exercise price of the put, have a value equal to the principal that is to be retired in the corresponding year. Should Tenant 104 default on the underlying lease, the tenant's stock or bonds would drop in value significantly. For example, if Tenant 104 goes bankrupt in year 3 of a ten-year lease, then the put options expiring at the end of years 3, 4, 5, 6, 7, 8, 9 and 10 will together cover the remaining principal balance. This gain may offset any losses from default by Tenant 104. If Tenant 104 reaffirms or Landlord/Borrower 130 re-lets the space successfully (see § VII.D, below), the hedge may simply earn additional income for Mezzanine Lender 102. The cost of the hedge may be paid for out of the excess spread earned from the Loan 100.

Similar arrangements may be synthesized using short sales of equity or debt of Tenant 104, one short position for each time period remaining in the loan tenor. The shorts allow Mezzanine Lender 102 to purchase the stock or bonds cheaply and deliver them at the higher strike price of the short. If Tenant 104 company defaults on the lease, Tenant 104 may also likely declare bankruptcy. CM-SPE 136 may then liquidate the short position at a price of essentially zero, allowing CM-SPE 136 to retain the price of the short, and cover the default.

In other cases, the default risk may be covered by an insurance wrap, or other financial derivative.

In some cases, Tenant corporation 104 against which the CDS or other hedging derivative is written may be unaware that this hedging transaction exists. Similarly, in some cases Landlord/Borrower 130 may be unaware of the hedge. Because no agreement of these parties is required, Mezzanine Lender 102 may obtain protection against loss without collateral that is part of the real estate capital structure. Similarly, there is no need (and often no opportunity) to reapportion the real estate collateral priorities between Senior Loan 112 and Mezzanine Loan 100.

In alternatives where the default risk is entirely hedged, the risk of Mezzanine Lender 102 and Investors 190 may be completely defeased, even though Mezzanine Lender 102 has no recourse to the property, to Tenant 104 or to Landlord/Borrower 130.

IV.B. Over-Collateralization Account

Referring to FIG. 2d, Mezzanine Loans 100 may be wrapped in Over-Collateralization Account 262, set aside out of the excess spread above the blended senior unsecured borrowing rate of Tenant 104, or by a premium at issue, to provide a significant recovery for Mezzanine Lender 102 or Investors 190 in the event of a default. Over-Collateralization Account 262 may be sized to provide six to eight months of payments to Investors 190, depending on the local market conditions, to provide for the timely payment of bond payments 196 during the time it takes for Landlord/Borrower 130 to re-let the vacant space. Therefore, as long as Landlord/Borrower 130 re-lets the space within this time, and Senior Lender 110 does not exercise remedies that impact re-letting, Over-Collateralization Account 262 may ensure that there is no default in the bond payments 196. If Landlord/Borrower 130 does not re-let the space in that period, there may be a cessation of payments 196 for some period, but ultimately payments may resume upon successful marketing of the vacant space, provided Senior Lender 110 does not have and exercise remedies during such period. Similarly, in the event that Tenant 104 defaults and enters bankruptcy, and Landlord/Borrower 130 chooses not to pay Senior Loan 112, and Senior Lender 110 forecloses, this same Over-Collateralization Account 262 may be paid to the Investors 190.

Over-Collateralization Account 262 may be targeted at 5-15% or more preferably, 7.5-10%, of the initial principal balance. In alternatives where Mezzanine Loan 100 is fully amortizing, this Over-Collateralization Account 262 grows relative to the principal loan balance over the tenor of the Loan 100 and may reach the average corporate bond recovery as a percent of remaining principal balance after 75% of the tenor has been reached. Depending on the degree to which bonds 192 have been repaid when such a default might occur, Over-Collateralization Account 262 may cover a significant portion, or even all, of the remaining principal balance.

In some alternatives, a separate Over-Collateralization Account 262 may be established to back each individual Mezzanine Loan 100 on a bankruptcy-remote basis from every other Loan 100 and its Over-Collateralization Account. In other alternatives, several Over-Collateralization Accounts 262 for several distinct Mezzanine Loans 100 may be pooled or cross-collateralized. For Investors 190 participating in a pool of Mezzanine Loans 100, the expected default and recovery rates for such a pool may equal that of typical corporate bonds as early as 20% of the blended tenor of the pooled Loans 100.

Use of an Over-Collateralization Account 262 may be most desirable in a securitized structure, such as a collateralized debt obligation. If Mezzanine Loans 100 are sold in whole loan form without an Over-Collateralization Account 262, rather than pooled or securitized, the buyer may receive an additional excess spread to compensate for increased risk of loss.

IV.C. Borrower's Liability Survives Default or Bankruptcy of Tenant

The loan documents 140, 150 may provide that in the event that Tenant 104 defaults on any rent payment, then unpaid debt service 156 on the Loan 100 may accrue, with interest, due to Lender 102 from Landlord/Borrower 130 if and when Tenant 104 (or any replacement tenant) begins making rent payments 108, regardless of when such payments may be made and regardless of any other remedies Mezzanine Lender 102 may have exercised or recoveries that may have been received on other financial structures. Further, until any shortfall has been recovered, the loan documents may provide that Mezzanine Lender 102 will receive 100% of the net cash flow and/or residual proceeds from the sale or refinancing of the property (subordinate to payment of any amounts due out of such proceeds towards Senior Loan 112).

The loan documents 140, 150 may provide that in the event that Tenant 104 enters bankruptcy, Landlord/Borrower 130 shall not take any action in connection with the bankruptcy without the prior consent of Mezzanine Lender 102. Mezzanine Lender 102 may be given the right, without obligation, to, vote, file and prosecute any and all claims of Landlord/Borrower 130 in any bankruptcy of Tenant 104. The loan documents 140, 150 may obligate Landlord/Borrower 130 to object to and use its best efforts to prevent any assumption and assignment of the lease to any future tenant with a lower credit rating than that of the original Tenant 104 as of the closing date of the Loan 100.

IV.D. Obligations of Tenant on Reaffirmation of Lease in Bankruptcy

In some alternatives, if Tenant 104 enters bankruptcy, and Tenant 104 desires to reaffirm the lease, Tenant 104 may be required to pay of either one year's rent or 15% of the remaining principal balance of the rent for up to three years. In another alternative, Tenant 104 may covenant to pay the rent reserved by the lease, without acceleration, for the greater of one year, or 15%, not to exceed three years, of the remaining tenor of the lease. Since Senior Lender 110 has the senior lien on the lease and may or may not choose to pursue this recovery, it may be difficult to predict what recovery may be available to Mezzanine Lender 102 and Investors 190. These covenants may be framed as obligations of Landlord/Borrower 130 to negotiate such prepayments by Tenant 104 as part of reaffirmation of the lease in bankruptcy.

IV.E. Full Recourse Due and Payable in Some Events

Mezzanine Loan 100 may become full recourse to Landlord/Borrower 130 and Principal Owner 132 in the event of certain “bad boy acts” or force majeur external events. “Bad boy acts” or “bad boy events” is an established term of art, varying slightly from transaction to transaction, generally relating to bad faith actions of the tenant, including misdirection of rent payments, erosion or destruction of collateral, requiring additional investment by the lender, or improper use of bankruptcy. Examples of “bad boy acts” may include any transfer or encumbrance of the property or any interest therein in violation of the loan documents, any change to the lease without the prior written consent of Mezzanine Lender 102, a voluntary bankruptcy filing by Landlord/Borrower 130, or in the event Principal Owner 132 or any officer, member, principal, representative or affiliate of Landlord/Borrower 130 files, solicits or joins in the filing of an involuntary petition against Landlord/Borrower 130, lack of cooperation by Landlord/Borrower 130 or Principal Owner 132, or any officer, member, principal, representative or affiliate of Landlord/Borrower 130 in a bankruptcy of Tenant 104 or Landlord/Borrower 130, lack of cooperation in creating or perfecting the subordinate assignment 138 of the lease (whether initially or with respect to any replacement lease), any default under Senior Loan that is not caused by an act or omission of Tenant 104, any termination of the lease by Tenant 104 except as a result of a casualty or condemnation, any default with respect to the special purpose entity covenants, or default with respect to the reporting requirements in the loan documents. External force majeur events may include environmental issues or new legislation that alters the bargain.

In certain events, Mezzanine Lender may have the right to require Landlord/Borrower 130 to prepay the Loan 100 in full by paying the outstanding principal balance plus all accrued interest and all other sums due under the loan documents, and possibly a prepayment consideration. These events may include any one or more of the following, unless approved by Mezzanine Lender 102: (a) any reduction in the rents payable by Tenant 104, (b) any refinancing, replacement, modification or restructuring of Senior Loan 112 resulting in an increase in the monthly payments due under Senior Loan 112, or resulting in Senior Lender 110 or any new holder of Senior Loan 112 being unwilling to maintain the rights of Mezzanine Lender 102, (c) any exercise by Senior Lender 110 of any rights or remedies under the Senior Loan documents, (d) if the lease terminates or for any reason Tenant 104 is no longer fully obligated under the lease, unless the lease is replaced with another satisfactory to Mezzanine Lender 102, (e) if Landlord/Borrower 130 no longer owns fee title to the property, or (f) the occurrence of an uncured event of default under the Loan Documents.

The terms of a Mezzanine Loan 100 may limit the right of Landlord/Borrower 130 to prepay the Loan 100, or may provide that any prepayment would include a yield maintenance premium.

IV.F. Limitation on Borrower Incurring Debt or Disposing of the Property

Loan documents 140, 150 may provide that any transfer of the property or of any ownership interest in Landlord/Borrower 130 or Principal Owner 132 shall require the prior written consent of Mezzanine Lender 102. In some alternatives, Mezzanine Lender 102 may be given absolute discretion to approve any transfer that would result in (a) a change in control of Landlord/Borrower 130, (b) Landlord/Borrower 130 or any single purpose entity holding equity in Landlord/Borrower 130 ceasing to be a single purpose entity, or (c) a dissolution or termination of Landlord/Borrower 130. Any such transfer may be subject to a fee payable to Mezzanine Lender 102.

Loan documents 140, 150 may limit the ability of Landlord/Borrower 130 or Principal Owner 132 to assume additional debt beyond Senior Loan 112 or ordinary trade payables, for example, by setting a minimum debt service coverage ratio, or a maximum level of trade payables.

IV.G. Required Reserves

In some alternatives, especially where Landlord/Borrower 130 is obligated under the lease to repair or maintain the property, and/or to pay taxes, insurance or any other monetary obligation, or where there may be some other risk exposure, Mezzanine Lender 102 may require Landlord/Borrower 130 to fund reserve accounts to cover these expenses. These reserves may be waived if reserves for the same purposes are maintained in connection with Senior Loan 112.

In the event that Landlord/Borrower/Owner 130, 134 retains some roof and structure obligations, for example under a NN lease, Landlord/Borrower/Owner 130, 134 may be required to post some form of capital reserve, equal to an estimate of the maximum cost for roof and structure repairs, either as a monthly reserve and/or as a premium charged at origination of Mezzanine Loan 100. In some alternatives, the capped amounts for the landlord's responsibilities may be reserved for out of the rents, placed in an initial reserve, or Landlord/Borrower/Owner 130, 134 may be required to take out a surety bond benefiting the Mezzanine Loan 100 in the amount of the capped obligation.

In some alternatives, any remaining risk (whether of condemnation, casualty, default of landlord obligations, repairs required by normal wear and age, etc.) may be covered by a capital reserve established to cover the risk. For example, Servicers 142, 152, may service a Mezzanine Loan 100 structure backed by a double-net (“NN”) lease that leaves some responsibility for roof and structure with Landlord/Owner 130, 132, 134. A third party may agree to advance the costs of repairs in the event the Landlord/Owner 130, 132, 134 defaults on a repair obligation, subject to repayment. This type of guarantee is offered by Midland Loan Services, Inc. of Overland Park, Kans., who may also serve as Servicers 142, 152. The guarantee may, in turn, be backed by a capital reserve, or a pledge by Mezzanine Lender 102 of its own pledge of the partnership interests in Landlord/Borrower/Owner 130, 132, 134, or junior assignment 138 of the lease. Note that this equity pledge or junior assignment may be pledged at almost no discount—Tenant 104 will only require expenditure for, for example, repairs to the roof and structure, if Tenant 104 intends to continue paying the lease.

The capital reserve may be funded in any of a number of ways. For example, it may be put up by Landlord/Borrower/Owner 130, 132, 134 at origination.

Alternatively, the capital reserve may be established by Mezzanine Lender 102, funded by a premium of 50 basis points added to the interest rate charged to Borrower/Owner 130, or an origination fee of about 75 basis points, to compensate Mezzanine Lender 102 for the expense of this enhancement. Mezzanine Lender 102 may contribute to this capital reserve until it reaches an amount agreed with the third party guarantor, typically about 25¢/sq. ft./year.

In some cases, reserves may be accumulated from each of several Loans 100, and may be cross-pledged to Servicers 142, 152.

A capital reserve established by Mezzanine Lender 102 may be the property of Mezzanine Lender 102, in which case it will become additional profit to Mezzanine Lender 102 in the event the Mezzanine Loan 100 is retired with the reserve amount intact. IN other cases, the capital reserve may be the property of investors 190, to be paid to them on retirement of Mezzanine Laon 100.

V. Reaffirmation Database

It may be desirable to develop a database of leases, bankruptcies, reaffirmations of leases in bankruptcy, and rates of success in re-letting space where leases are not reaffirmed. Such statistical data on reaffirmation may substantially improve the ability of the rating agencies and investors to accurately assess the default probability for Mezzanine Loans 100. This information may enable better, higher ratings and therefore better execution through lower overall cost-of-funds.

This database may be gathered by examining bankruptcy filings over several prior years in the bankruptcy and district courts in the United States, focusing on investment grade companies, and determining whether the identified companies are still occupying the same offices and other premises. If companies have vacated the premises they had occupied prior to filing bankruptcy, a researcher may attempt to identify whether the vacating of the property was related to the bankruptcy or was in the ordinary course of business. Examples where the companies vacated certain premises may be classified by the type of property that was vacated (i.e., office, warehouse, manufacturing, distribution, etc.), the geographic location, the size of the company, and the credit rating of the company at the time of filing.

Such database may enable investors and rating agencies to assess probability of reaffirmation by type of industry, property use, size of company, credit grade, and geography. This may improve the underwriting process, the ratings of securitizations, and the ultimate pricing and yields investors receive. The database may allow for Lender 102 to take out more spread in the form of the residual interest or premium price obtained, or lower prices and yet still lend profitably. Better default frequency information may cause Investors 190 to value Loans 100 and Bonds 192 more highly.

VI. Increased Opportunities for Structuring Financing

Referring to FIG. 3, in some cases, Senior Lender 110 takes a lien 302 on the property itself, and Mezzanine Lender 102 takes a pledge of partnership interest of the shares of Landlord/Borrower 130 and/or Principal Owner 132, and/or the partnership or special purpose entity that owns the property. In this arrangement, all interests of Landlord/Borrower 130 and Principal Owner 132 have been encumbered, and there is no further collateral 306 available for a third loan.

In other cases, a Mezzanine Loan structure may be structured so that the Senior Lender 110 and Mezzanine Lender 102 take control 312, 314 of the lease payments, and leave the property itself and the partnership interests 316 unencumbered, available as collateral for third and fourth mortgages.

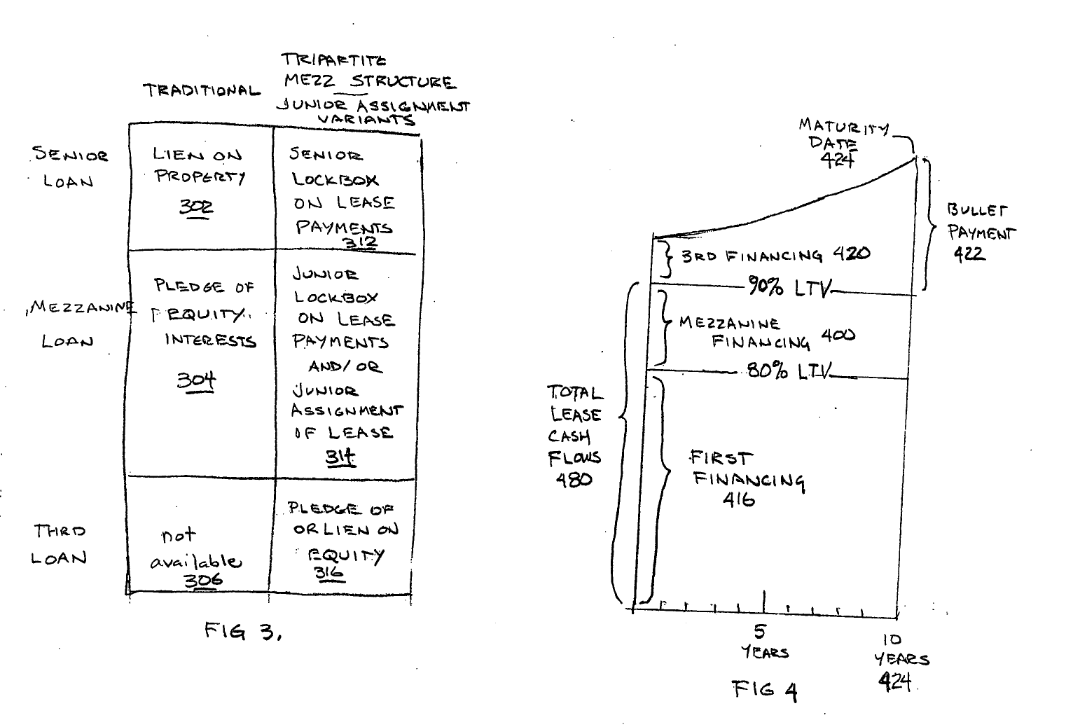

Referring to FIG. 4, Landlord/Borrower 130 may obtain financing whose payments exceed the total amount supported by the lease cash flows. In FIG. 4, the total monthly payments 480 on Senior Loan 416 (with a lien on the property) and second financing (a Mezzanine Loan) 400, and whatever incidental expenses are to be borne by Landlord/Borrower 130 (such as taxes, maintenance, and utilities, to the degree these have not been contracted out to Tenant 104 under a double net or triple net lease) may equal the total 480 of the lease cash flows. Because the ownership interest remains unencumbered, Landlord/Borrower 130 may borrow an additional third amount 420 on a zero-coupon note collateralized by the ownership interest, to be repaid in a bullet payment 422 of principal and accrued interest at the end 424 of the lease tenor. This may provide increased leverage for owners of commercial real estate.

Further, the Mezzanine Loan structure may provide additional options and optimization of the capital structure for a real estate asset. The Senior Loan 416 may typically obtain a rating of the tenant's corporate bonds (or possibly better), suitable for a typical insurance company investment. The second financing 400, under a Mezzanine Loan structure, may have a slightly higher yield and yet still be investment grade, suitable for the typical corporate bond investor. The third bullet financing 420 may carry a high yield appropriate for certain investors, for example, the typical junk bond investor. Thus, by balancing the amounts of the different tiers of financing, the Mezzanine Loan structure may provide some combination of greater cash flows for Landlord/Borrower 130, higher loan-to-value leverage, lower interest rate, or longer tenor for Landlord/Borrower 130.

A Mezzanine Loan structure may be used with a traditional mortgage, with commercial mortgage backed securities (CMBS), credit tenant lease (CTL) senior debt forms, or other senior financing.

VII. Investor Valuation of Mezzanine Bonds

A Mezzanine Loan 100 may have credit characteristic of a senior unsecured direct obligation of Tenant 104, that can only go into default if Tenant 104 defaults on its rent obligation by entering bankruptcy. Even though a Mezzanine Bond 192 is subordinate to Senior Loan 112, it may have credit characteristics of a senior unsecured term debt obligation of Tenant 104 backed by the underlying space lease obligation, and should perform in a similar manner. That is, a Mezzanine Loan 100 should go into default for the same reasons and under the same circumstances as any other senior unsecured debt of Tenant 104 in the corporate debt markets. As will be discussed in § VII.D, Mezzanine Loan 100 may actually perform better than corporate debt counterparts.

VII.A. Loan Pricing Arbitrage

Traditional commercial mezzanine loans are priced (that is, interest rate and various fees) by the risk associated with property value leverage or loan-to-value (“LTV”) and their rates are sensitive to change in LTV. Regardless of the credit quality of Tenant 104, traditional mezzanine loan pricing increases fairly linearly with the increase in LTV. In contrast, the pricing of Mezzanine Loan 100 may be entirely independent of LTV leverage, and is related nearly solely to the credit quality of Tenant(s) 104. Thus the pricing may be based on the senior unsecured borrowing rate of Tenant(s) 104. As LTV increases, the credit quality of Tenant 104 is unaffected, and the pricing may remain nearly the same.

Therefore, Mezzanine Loan 100 may have an increasing advantage as LTV leverage increases. As tenant credit quality increases, pricing of Mezzanine Bonds 192 may decrease, decrease in staggered steps, or may remain fixed. Rates might be 10% for loans to A and BBB credit grade tenants and 9% for AAA and AA credit tenants. The spread between the loan rate and the bond coupon may be determined by the credit of a specific Tenant 104 and the tenor of the loans. If the average life of the Loan 100 or Bond 192 is six years, and the Swap rate for six years is 3.1%, and the tenant's unsecured borrowing rate spread is 175 basis points, then the base bond coupon would be 4.85%.

A further premium may be added to allow for prepayment, illiquidity, and subordination. The prepayment premium might be 75 basis points, depending on the credit quality of Tenant 104, the lockout period, and the tenor of Bonds 192. The illiquidity and subordination premiums may be fairly static. A portion of the premium allocated to illiquidity may compensate Investors 190 for the fact that this is a new asset class and investors may be expected to hold the Bonds 192 to maturity or until a secondary market in Mezzanine Bonds 192 develops. The portion allocated to subordination may compensate the Investors 190 for their position of being subordinate to Senior Lender 110 in the event of a default. The combined premium may be about 100 basis points. Thus, in the example, the Mezzanine Loan bond coupon might be expected to be about 6.6%. This would provide a spread of 340 basis points between the 10% loan rate and the bond coupon.

In 2003, commercial mezzanine loans are usually made at rates ranging from 12-13% for eighty-percent aggregate capitalization (80 LTV) to 20% or more for ninety-percent aggregate capitalization (90+LTV) and have repayment tenors of three to five years. In contrast, a Mezzanine Loan 100 may carry a rate of (5%-12%) for investment grade tenants (possibly higher for lower grade tenants), and may extend for about ten years.

Unlike traditional mezzanine debt, the Mezzanine structure may avoid the need for an inter-creditor agreement between Mezzanine Lender 102 and Senior Lender 110. In many alternatives, the Mezzanine structure may not require such an agreement because Mezzanine Loans 100 give Mezzanine Lender 102 no interest in the partnership, and do not create situations in which Mezzanine Lender 102 can become the operator of the property, the obligor to Senior Lender 110, or otherwise acquire any interest in the property.

VII.B. Valuation of Bonds Issued by a Mezzanine Structure

Mezzanine Bonds 192 may compare favorably with corporate bonds issued by Tenant 104. Even though a Mezzanine Bond 192 may have a lower frequency of default, greater recovery and lower loss severity than a corporate bond of Tenant 104, Mezzanine Bonds 192 may provide higher yields to Investors 190.

Mezzanine Bonds 192 may be underwritten based on the character of existing leases and the credit quality of Tenant 104. Real estate lease obligations are similar in many ways to corporate bonds and may be valued by bond valuation techniques that measure the certainty of the cash flows over the tenor of the lease. Like other lease collateralized loans, Mezzanine Bonds 192 may be valued based on the existing leases, tenant quality and default risk, a risk premium over treasuries of a comparable corporate bond, severity, duration, and the excess lease cash flows after servicing 146, 156 the mortgage debt, avoiding speculation on the real estate's future value.

VII.C. Subordinate, But Really Pari-Passu

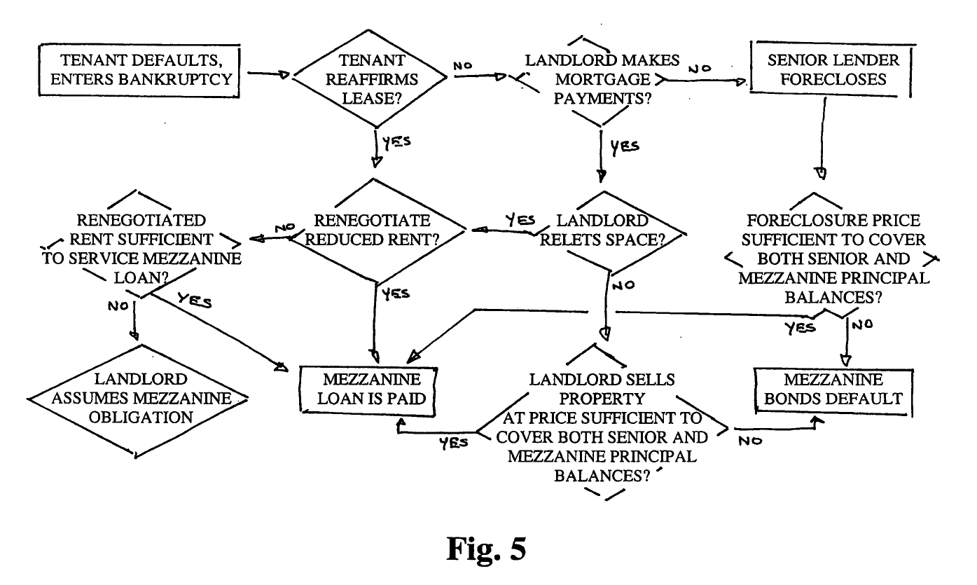

Referring to FIG. 5, in alternatives where a Mezzanine Loan structure includes a subordinate assignment 138 of the lease rent and cash flows, the collateral is technically subordinate to the interest of Senior Lender 110. Similarly, Mezzanine Loan payments are subordinate to Senior Loan 112. In the event of a default by Tenant 104 or Landlord/Borrower 130, Mezzanine Loan Bond payments 156, 196 are subordinate to Senior Lender 110 taking possession of the property and the rent cash flows. A default by Tenant 104 or Landlord/Borrower 130 could result in a foreclosure on Senior Loan 112 or Senior Lender 110 otherwise taking possession of the property and all of the rent cash flows 108. All that Mezzanine Lender 102 may receive in this scenario is the remaining principal balance and any Over-Collateralization Account 262.

However, as a practical matter, with a single tenant property, Tenant 104 either makes the entire lease rent payment or not at all. If Tenant 104 defaults, files for bankruptcy, and rejects the lease, Tenant 104 will not make the payment. In this event, Senior Lender 110, who has a senior claim on the lease payments, will receive little or no payment, and neither will Mezzanine Lender 102. In nearly all other scenarios, Tenant 104 makes the payment, and both Senior Lender 110 and Mezzanine Lender 102 receive their entire payments 146, 156. Thus, as a practical matter, Senior Lender 110 and Mezzanine Lender 102 may be effectively pari-passu to one another with respect to the lease rent cash flows 108.

VII.D. Evaluating Credit Default Risk

The credit risk of a Mezzanine Loan 100 is composed of the default probability and potential loss severity. As will be shown below, the probability of default on a Mezzanine Loan 100 is:
Mezzanine Loan Probability of Default=P*(1-R)*(1-L)
where
P=Probability Tenant Defaults on Lease≈Probability of default on corporate bonds
R=Probability Tenant Reaffirms Lease
L=Probability Lessor Re-lets Space in 8 months
Industry surveys indicate that R, the probability that Tenant 104 reaffirms the lease in bankruptcy, is about 60%. Similarly, industry surveys indicate that L, the probability that Landlord/Borrower 130 re-lets within 8 months (that is, within the coverage lifetime of Over-Collateralization Account 262, see § IV.B), is about 75%. Together, these suggest that the default rate on Mezzanine Bonds 192 may be about 10-40% the rate of default on the Tenant's corporate bonds.

The expected loss calculation is the following:
Expected Loss=(Probability of default)*(remaining principal balance)*(1-Recovery Rate)
It is estimated that the frequency of default of a Mezzanine Loan 100 may be under 30% of the traditional corporate bond default rate. Loss severity on Mezzanine Loan 100 may be greater than that for a corporate bond in the first several years and less than that for corporate bonds in the later years of the tenor. Recovery rates may be superior to that of corporate bonds of Tenant 104 for a variety of reasons discussed below in §§ VII.D.1 to VII.D.5. Together, these calculations show that expected loss severity of Mezzanine Loans may be considerably better than that of corporate bonds.
VII.D.1. Reaffirmation of Leases in Event of Bankruptcy

When a corporation enters bankruptcy (step 502), the corporation will default on its corporate bonds and the bondholders join the bankruptcy as unsecured creditors. Most often, all of the corporation's leases go into technical or real default at the same time. At this point, the corporate bond and Mezzanine Loan 100 would both be in default. However, the corporate bond will remain in default until the bankruptcy is fully resolved and the courts determine how much money is to be paid against the remaining principal balance, or until the corporation exits bankruptcy and begins to resume payments under a negotiated arrangement.

Investors 190 of Mezzanine Bonds 192 may stand in better position than corporate bondholders.

First, the corporation in Chapter 11 bankruptcy may reaffirm (step 504) its lease for the space and then resume its lease payments without interruption (step 506), and thus the payments on Mezzanine Loans. Approximately 60% of companies maintain their headquarters office space while under Chapter 11 bankruptcy protection, and affirm their leases in the event of bankruptcy. For this reason, Mezzanine Loans 100 are most favorably written against property that are central to the core operation of the tenant's business, rather than facilities that could be readily eliminated in the event of bankruptcy.

In some cases, Tenant 104 may renegotiate (step 510) a reduced rent. Mezzanine Loan agreements 140, 150 may require that Landlord/Borrower 130 negotiate a reaffirmation that at least covers all required cash flows to pay the monthly payment 156 on Mezzanine Loan 100, the senior debt service 146 and any expenses 182 to operate and own the building, for example, taxes, insurance, capital improvements, maintenance, and utilities. In the event that Landlord/Borrower 130 negotiates a rent amount that is insufficient to cover Loan payments 156 (step 512), the loan agreement may provide Mezzanine Lender 102 with full recourse to Landlord/Borrower 130 and Principal Owner 132 (step 514). So, even where Tenant 104 enters bankruptcy, payments 196 on Mezzanine Bonds 192 may continue uninterrupted (step 520). In this aspect, Mezzanine Bonds 192 may be superior to a corporate bond.

In some cases, Tenant 104 may default on its lease and rent payments 108. Payments 146 to Senior Lender 110 will go into default, and Senior Lender 110 will foreclose on the property and attempt to recover its unpaid principal balance by selling the property. In cases where Mezzanine Loan structure 100 places no lien on the property, Mezzanine Lender 102 may receive no proceeds from this sale, and may have no recourse against Landlord/Borrower 130 or Principal Owner 132 or the property.
VII.D.2. Re-Letting Vacated Space

In the event that Tenant 104 declares bankruptcy and defaults, but does not reaffirm its lease and vacates the property (step 530), the remaining principal balance of Mezzanine Loans 100 may still be timely repaid. Landlord/Borrower 130 will usually have every incentive to re-lease or re-let the space to another tenant (step 532). In alternatives in which Mezzanine Loan agreements 140, 150 require that Landlord/Borrower 130 assigns any future leases and rent cash flows to the cash flow management structure 136, 140, 150, payments 156, 196 will resume on successful re-leasing (step 520). In contrast, with a corporate bond, there is no analogous “substitution” provision.

On average, there is a 75% probability that space vacated by bankrupt Tenant 104 will be re-let in less than 8 months. In some alternatives, Over-Collateralization Account 262 (see § IV.B) may provide six to eight months of bond payments 196, depending on the local market conditions. Therefore, as long as Landlord/Borrower 130 re-lets the space within this time, there may be no default in bond payments 196.

Mezzanine Loan structure 100 may retain some element of real estate risk, in that a declining or bad real estate market may reduce the ability of Landlord/Borrower 130 to re-let the space after a default by Tenant 104, in cases where the lease is terminated or Tenant 104 goes bankrupt and does not reaffirm the lease.
VII.D.3. Default

Thus, there are two scenarios that may lead to a default on Mezzanine Loan payments 156 and bond coupons 196: (a) where Tenant 104 reaffirms the lease at a rent that is insufficient to cover the debt service 156 on Mezzanine Loan 100 (step 512). In these cases, Mezzanine Lender 102 may have recourse against Landlord/Borrower 130 and/or Principal Owner 132, as discussed in § IV.E, and (b) where Tenant 104 rejects the lease and Landlord/Borrower 130 is unable to re-let the space, and Senior Lender 110 forecloses (step 540). In this case, any excess 542 of the foreclosure price over the principal remaining on Senior Loan 112 may be payable to Mezzanine Lender 102.
VII.D.4. Loss Severity

Unless Mezzanine Loan 100 is pooled (e.g., as discussed in § III.B) or hedged or otherwise covered (e.g., using one or more of the techniques discussed in § IV), the severity of Mezzanine Loan 100 is 100% versus the historical average severity of 65-75% for corporate debt obligations. (According to “Default & Recovery Rates of Corporate Bond Issuers,” Moody's (February 2002), the average corporate bond recovery is 35% of the remaining principal balance, drifting downward over the past several years, and varying considerably by industry sector). However, where such coverage has not been provided, Mezzanine Lender 102 and Investors 190 may receive a higher coupon whose excess spread may be viewed as the recovery.

Further, a Mezzanine Loan 100 may be a fully amortizing loan, while a typical corporate bond pays interest only during its tenor, with 100% of the principal due in the 10th year. Because of the amortization of the balance remaining in the Mezzanine structure 100, the expected loss variance between the corporate bonds and a Mezzanine Bond 192 may increase over time.
VII.D.5. Recovery

Recovery rates on Mezzanine Bonds 192 may be compared to corporate bond default. When a corporation enters bankruptcy, a lengthy process ensues involving the corporate management, the courts and the creditors. After a considerable period of time, the creditors, including the bondholders, receive a percentage of what they are owed. This recovery can vary from 100% of the principal to nothing.

Mezzanine Loan 100 recovery may include amounts received from Tenant 104 on reaffirmation of the lease (see, e.g., §§ IV.D, VII.D.1), from a successor tenant (see § VII.D.2), from Over-Collateralization Account 262 (see § IV.B), from Landlord/Borrower 130 and/or Principal Owner 132 (see, e.g., §§ IV.C and IV.E), from insurance and hedging (see, e.g., §§ IV.A and II.C.1(b)) and various reserves (see, e.g., § IV.G).

Further recovery may be available from residual or “go dark” value of the underlying real estate. In addition, Senior Lender 110, especially on a single-tenant building, may have reserves created from property cash flow to account for leasing commissions and tenant improvement costs. If the “go dark” value of the property plus the value of these reserves exceeds the sum of the balances due on Senior Loan 112 and Mezzanine Loan 100, some recovery may flow to Mezzanine Lender 102 and to Investors 190. Since Mezzanine Loan 100 is subordinate to Senior Loan 112, the probability that these recoveries will be sufficient to pay down both loans may be fairly low, although the recovery rate increases over time as Senior Loan 112 and Mezzanine Loan 100 amortize.

Additional recovery may be possible in alternatives where Mezzanine Lender 102 has access to Tenant 104 as an unsecured subordinate creditor under the assignment 138 of lease, but this amount may be expected to be less than 5%.

VIII. Uses

Mezzanine Loan 100 may utilize 100% of excess cash flows to generate maximum proceeds for the acquisition of a net leased property occupied by a single credit tenant. Where maximum leverage is desired, a fully amortizing Mezzanine Loan 100 may be preferred. Where maximum proceeds are not necessary, bridge financing with a short-term interest only Mezzanine Loan 100 may be preferred. Mezzanine Loan 100 may be most attractive when the senior lender can offer a 30-year amortization schedule and the mortgage term equals or exceeds the expiration of the credit lease.

The Mezzanine Loan 100 structure may provide proceeds up to the present value of 100% of the cash flow in excess of the senior mortgage debt, where the discount rate is determined based on the credit of the tenant and the average life of the financing. The discount rate is equal to the average life SWAP rate plus the off the rack spread value of the tenant.

Owners of net lease real estate can use the Mezzanine Loan structure 100 to monetize underutilized cash flows through equity take out financing. Often, property owners can monetize excess cash flows at spreads below 200 Basis points, that is at rates just slightly above corporate line spreads, but without balance sheet recourse. This provides real estate CFO's with an attractive tool to raise capital without utilizing their existing corporate lines. Mezzanine Loan structure 100 may also be used by real estate fund managers to pay investor distributions reflecting the value created by new credit tenant leases, without the need to sell the property to realize such. Similarly, real estate developers can extract additional capital from completed properties leased to single credit tenants, and deploy the proceeds to new development projects. Since Mezzanine Loan structure 100 is a passive instrument, implementation alongside existing senior mortgage debt may be greatly facilitated.

IX. Computer Implementation

Mezzanine structure 100 may be managed by one or more computers. For example, one or more computers may be programmed to generate invoices, payments, statements, and other reports, maintain records, etc. for one or more of the steps described above.

Computer software 250 for originating, managing and analyzing Mezzanine Loans 100 may be provided, for example, by Lender 102 or a service bureau affiliated with Lender 102. Such software may improve market efficiencies or capture surpluses in market inefficiencies. The software may further provide electronically integrated loan origination primary and secondary loan transactions, information management, and related services, data storage, risk management, allowing tenants 104 and Owner 130, 132 to consolidate and centralize activities for originating and servicing Mezzanine Loans 100. The software may enable tenants, landlords, lenders, brokers or leasing agents, to (a) model a structure for Mezzanine Loans 100 in comparison to traditional financing alternatives, (b) apply directly to a lender's credit underwriting department for a loan based upon input provided, (c) receive electronic notification of credit determination, and (d) receive coordination support throughout the closing process. Access to the software may be provided over the internet on a thin client basis, from a central server array, or through other computer access networks. The computer may intermediate a series of vertical and horizontal corollaries in the commercial office and real estate finance markets, including tenant improvement construction loans, real estate and leasing information management, and coordination with other real estate finance markets. Initial underwriting of Mezzanine Loan 100 may be performed with the assistance of a computer model. Some of the transaction documents may be generated by word processing software.

Pricing information may be made available to landlord/borrowers at a web site. For example, the web site may provide specific pricing for specific tenants that have publicly-traded credit default swaps, or that have publicly-traded securities that can be used to synthesize a hedge (see § IV.A.2). The web site may also provide generic pricing information based on credit grade of the tenant. Some of this pricing information may be in password-accessible portions of the web site, while other information may be publicly-visible.

For the convenience of the reader, the above description has focused on a representative sample of all possible alternatives, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

1. A method, comprising the steps of:
receiving a payment on a junior loan paid to a junior lender on a loan made to an owner of commercial real estate, the real estate being under lease from the owner to a tenant:
ownership of the real estate and of a lease of the real estate being arranged in one or more special-purpose entities (SPE's) bankruptcy remote from obligations unrelated to the real estate, the owner SPE owing a senior financing to a senior lender and the junior loan to the junior lender;
an interest rate of the junior loan being based on the credit of the tenant;
a term of the junior loan being no longer than the term of the lease and no longer than the term of the senior financing;
the junior loan being secured by payments under a lease of an asset, either the lease providing a bond-type guarantee of payment of rents under the lease or the lease being enhanced by one or more financial instruments to provide a bond-equivalent guarantee of payment;
the junior loan collateralized at least in part by (a) a pledge to the junior lender of rent cash flows generated by the lease, (b) a junior assignment of rents under the lease to the junior lender, the junior assignment being junior to any assignment of rents to the senior lender, or (c) a pledge of the ownership interests of the owner of the real estate, terms of the junior loan being otherwise non-recourse against the real estate, the owner, or a tenant of the real estate except at most bad boy acts and force majeur events;
the owner SPE having surrendered over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant;
at least one step of originating, managing or servicing the loan being performed with the assistance of a computer.

2. A method, comprising the steps of:
receiving a payment on a junior loan, the junior loan owed by an owner of commercial real estate to a junior lender:
ownership of the real estate and of a lease of the real estate being arranged in one or more special-purpose entities bankruptcy remote from obligations unrelated to the real estate, the owner owing a senior financing to a senior lender and the junior loan to the junior lender, the junior loan being independent of the senior financing;
the owner having surrendered over to a lockbox arrangement the right to rents paid by a tenant under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant; and
at least one step of originating, managing or servicing the loan having been performed with the assistance of a computer.

3. The method of claim 2, wherein:
the junior loan is collateralized at least in part by an assignment of rents under the lease junior to any assignment to the senior lender.

4. The method claim 3, wherein:
the junior loan is collateralized without a mortgage foreclosable by the junior lender against the real estate.

5. The method of claim 3, wherein:
payments to the junior lender are guaranteed by a financial derivative arranged to cover default of the tenant on rents under the lease.

6. The method of claim 5, wherein:
the financial derivative is a credit default swap.

7. The method of claim 3, wherein:
the owner has covenanted under the terms of the junior loan, in the event of default by the tenant, to surrender rents under any replacement lease to the lockbox arrangement.

8. The method of claim 2, wherein:
payments to the junior lender are guaranteed by a financial derivative arranged to cover default of the tenant on rents under the lease.

9. The method of claim 8, wherein:
the financial derivative is a credit default swap.

10. The method of claim 2, wherein:
the lease imposes bond-type payment obligations on the tenant.

11. The method of claim 2, a term of the junior loan being no longer than the term of the lease and no longer than the term of the senior financing.

12. The method of claim 2, a term of the junior loan being no longer than the term of the lease and no longer than the term of the senior financing.

13. The method of claim 2, wherein:
the lockbox arrangement includes two different servicers or custodians of different depository accounts for servicing the junior loan and senior financing, respectively.

14. The method of claim 2, wherein:
a single servicer makes the payments to the senior and junior lenders from a single depository account.

15. The method of claim 2, wherein:
the lockbox arrangement being under control of a cash management special purpose entity with powers to collect rent and distribute proceeds to the senior and junior lenders.

16. The method of claim 2, wherein:
the lockbox arrangement further makes a payment for operating expenses or taxes before the owner receives any residual of the lease payments.

17. The method of claim 2, wherein:
the terms of the junior loan have the effect of imposing requirements on the tenant in event the tenant enters bankruptcy and reaffirms the lease.

18. The method of claim 2, wherein:
the terms of the lease obligate the tenant to continue to pay rent in the case of at least a partial condemnation taking, and terms of the loan provide recovery to the junior lender against any recovery by tenant or landlord for the condemnation.

19. The method of claim 2, wherein:
the lease is a single-tenant lease.

20. The method of claim 2, wherein:
the real estate is a multi-tenant property, and the owner has surrendered over to a lockbox arrangement the right to rents paid by several tenants of the real estate.

21. The method of claim 2, further comprising the step of:
the junior lender issuing obligations backed by the payments from the lockbox arrangement.

22. The method of claim 21, wherein:
the obligations include a private placement participating or syndicating the loan.

23. The method of claim 21, further comprising the step of:
reserving at least part of the junior payment for an over-collateralization account for the protection of the obligations.

24. The method of claim 21, wherein:
the junior lender secures a put, short, swap, insurance, or other protection against default of the tenant.

25. A method, comprising the steps of:
advancing a junior loan from a junior lender to an owner of commercial real estate, ownership of the real estate and of a lease of the real estate being arranged in one or more special-purpose entities bankruptcy remote from obligations unrelated to the real estate, the owner owing a senior financing to a senior lender and the junior loan to the junior lender, the junior loan being independent of the senior financing;
the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant;
at least one step of originating, managing or servicing the loan being performed with the assistance of a computer.

26. The method of claim 25, wherein:
the junior loan is collateralized at least in part by a pledge to the junior lender of rent cash flows generated by a lease of the real estate.

27. The method of claim 26, wherein:
the terms of the junior loan are non-recourse against the real estate, the lessor of the lease, or a tenant of the real estate, except at most in the event of bad boy acts and force majeur events.

28. The method of claim 25, wherein:
the junior lender has a guarantee of payment either under a bond-type lease or under a derivative contract providing equivalent guarantee of payment.

29. The method of claim 28, a term of the junior loan being no longer than the term of the lease and no longer than the term of the senior financing.

30. The method of claim 25, a term of the junior loan being no longer than the term of the lease and no longer than the term of the senior financing.

31. The method of claim 25, wherein:
the junior lender has obtained financing based on the credit of the tenant of the lease.

32. The method of claim 25, further comprising the step of:
the owner covenanting under the terms of the junior loan, in the event of default by the tenant, to surrender rents under any replacement lease to the lockbox arrangement.

33. The method of claim 25, wherein:
the lockbox arrangement includes two different servicers or custodians of different depository accounts for servicing the junior loan and senior financing, respectively.

34. The method of claim 25, wherein:
the junior loan is advanced after the senior financing.

35. The method of claim 25, wherein:
the junior loan is advanced contemporaneously with the senior financing.

36. The method of claim 25, wherein:
the terms of the lease obligate the tenant to continue to pay rent in the case of at least a partial condemnation taking, and terms of the loan provide recovery to the junior lender against any recovery by tenant or landlord for the condemnation.

37. The method of claim 25, wherein:
the real estate is a multi-tenant property, and the owner has surrendered over to a lockbox arrangement the right to rents paid by several tenants of the real estate.

38. The method of claim 25, further comprising the step of:
the junior lender issuing obligations backed by the payments from the lockbox arrangement.

39. The method of claim 25:
the independence of the junior loan from the senior financing being due, at least in part, to independence of the junior lender from the senior lender.

40. The method of claim 25:
the independence of the junior loan from the senior financing being due, at least in part, to origination of the junior loan underneath a pre-existing senior financing, with at most minimal reformation of the terms of or re-underwriting of the senior financing.

41. A method, comprising the steps of:
receiving a payment on a junior loan, the loan made by a junior lender to an owner of commercial real estate, the owner owing a senior financing to a senior lender and the junior loan to the junior lender, the junior loan being independent of the senior financing, the junior loan collateralized at least in part by a junior assignment of rents under the lease in lieu of a mortgage foreclosable by the junior lender against the real estate, the junior assignment being junior to any assignment of rents to the senior lender;
at least one step of originating, managing or servicing the loan having been performed with the assistance of a computer.

42. The method of claim 41, wherein:
payments to the junior lender are guaranteed by a financial derivative arranged to cover default of the tenant on rents under the lease.

43. The method of claim 42, wherein:
the financial derivative is a credit default swap.

44. The method of claim 41, wherein:
an owner of the real estate and of a lease of the real estate has surrendered over to a lockbox arrangement the right to rents paid under the lease, the lockbox being obligated to make a senior payment to a senior lender and a junior payment to the junior lender before the owner receives any residual of the lease payments.

45. A method, comprising the steps of:
advancing a junior loan from a junior lender to an owner of commercial real estate, the owner owing a senior financing to a senior lender and the junior loan to the junior lender, the junior loan being independent of the senior financing, the junior loan collateralized at least in part by a junior assignment of rents under the lease in lieu of a mortgage foreclosable by the junior lender against the real estate, the junior assignment being junior to any assignment of rents to the senior lender;
at least one step of originating, managing or servicing the loan being performed with the assistance of a computer.

46. The method of claim 45, wherein:
an interest rate of the junior loan is based on the credit of the tenant.

47. The method of claim 45, wherein:
the lease imposes bond-type payment obligations on the tenant.

48. The method of claim 45, further comprising the step of:
entering a derivative contract that provides a payment guarantee to the junior lender equivalent to that of a bond-type lease.

49. The method of claim 48, a term of the junior loan being no longer than the term of the lease and no longer than the term of the senior financing.

50. The method of claim 45, a term of the junior loan being no longer than the term of the lease and no longer than the term of the senior financing.

51. The method of claim 45:
wherein ownership of the real estate and of a lease of the real estate being are arranged in one or more special-purpose entities bankruptcy remote from obligations unrelated to the real estate;
and further comprising the step of the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant.

52. A method, comprising the steps of:
receiving a payment on a loan, the loan made by a lender to an owner of an asset, the asset being under lease from the owner to a tenant, payments on the loan secured by payments under the lease, payments to the junior lender being guaranteed by a financial derivative arranged to cover default of the tenant on rents under the lease;
at least one step of originating, managing or servicing the loan having been performed with the assistance of a computer.

53. The method of claim 52, wherein:
the financial derivative is a credit default swap.

54. The method of claim 52, wherein:
the loan covered by the financial derivative is a junior loan, and the lender is a junior lender, the asset encumbered by a senior financing from a senior lender.

55. The method of claim 54, wherein:
the asset is an interest in commercial real estate.

56. The method of claim 55, wherein:
wherein an owner of the real estate and of a lease of the real estate has surrendered over to a lockbox arrangement the right to rents paid under the lease, the lockbox being obligated to make a senior payment to a senior lender and a junior payment to the junior lender before the owner receives any residual of the lease payments.

57. The method of claim 55, wherein:
the junior loan is collateralized neither by a pledge nor a lien over the real estate nor against any ownership interest in any entity with an ownership interest in the real estate, except at most in the event of bad boy acts and force majeur events.

58. The method of claim 55, wherein:
the junior loan has a payment priority that is senior to all other obligations of the owner except the senior financing, terms of the junior loan being non-recourse against the real estate, the owner, or a tenant of the real estate except at most bad boy acts and force majeur events.

59. The method of claim 55, wherein:
the terms of the lease obligate the tenant to continue to pay rent in the case of at least a partial condemnation taking, and terms of the loan provide recovery to the junior lender against any recovery by tenant or landlord for the condemnation.

60. The method of claim 55, wherein:
the lease is a single-tenant lease.

61. The method of claim 55, wherein:
the real estate is a multi-tenant property, and the owner has surrendered over to a lockbox arrangement the right to rents paid by several tenants of the real estate.

62. The method of claim 61, wherein:
the owner has covenanted under the terms of the junior loan, in the event of default by the tenant, to surrender rents under any replacement lease to the lockbox arrangement.

63. A method, comprising the steps of:
originating a loan from a lender to an owner of commercial real estate, the real estate being under lease from the owner to a tenant, the principal of the loan being guaranteed by a financial derivative arranged to cover default of the tenant on rents under the lease;
at least one step of originating, managing or servicing the loan being performed with the assistance of a computer.

64. The method of claim 63, wherein:
the loan covered by the financial derivative is a junior loan, and the lender is a junior lender, the owner owing a senior financing to a senior lender.

65. The method of claim 64, wherein:
the financial derivative is a credit default swap.

66. The method of claim 64, wherein:
an interest rate of the junior loan is based on the credit of the tenant.

67. The method of claim 63, a term of the junior loan being no longer than the term of the lease and no longer than the term of a senior financing of the real estate.

68. The method of claim 63, a term of the junior loan being no longer than the term of the lease and no longer than the term of a senior financing of the real estate.

69. The method of claim 64, further comprising the step of:
the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant.

70. The method of claim 64, wherein:
the junior loan is collateralized at least in part by a junior assignment of rents under the lease in lieu of a mortgage foreclosable by the junior lender against the real estate, the junior assignment being junior to any assignment of rents to the senior lender.

71. The method of claim 63, wherein:
the terms of the junior loan have the effect of imposing requirements on the tenant in event the tenant enters bankruptcy and reaffirms the lease.

72. The method of claim 63, further comprising the step of:
the junior lender issuing obligations backed by the payments from the lockbox arrangement.

73. The method of claim 72, wherein:
the obligations include a private placement participating or syndicating the loan.

74. The method of claim 72, wherein:
the obligations include a publicly-issued security.

75. The method of claim 72, further comprising the step of:
reserving at least part of the junior payment for an over-collateralization account for the protection of the obligations.

76. The method of claim 72, wherein:
the junior lender secures a put, short, swap, insurance, or other protection against default of the tenant.

77. A method, comprising the steps of:
receiving a payment on a junior loan, the loan made by a junior lender to an owner of commercial real estate:
an owner of the real estate and of a lease of the real estate having surrendered over to a lockbox arrangement the right to rents paid under the lease, the lockbox being obligated to make a senior payment to a senior lender and a junior payment to the junior lender before the owner receives any residual of the lease payments; and
the junior loan collateralized by a pledge to the junior lender of rent cash flows generated by a lease of the real estate, and neither a pledge nor a lien over the real estate nor against any ownership interest in any entity with an ownership interest in the real estate, except at most in the event of bad boy acts and force majeur events;
at least one step of originating, managing or servicing the loan having been performed with the assistance of a computer.

78. The method of claim 77, wherein:
an interest rate of the junior loan is based on the credit of the tenant.

79. The method of claim 77, wherein:
the junior lender has a guarantee of payment either under a bond-type lease or under a derivative contract providing equivalent guarantee of payment.

80. The method of claim 77, a term of the junior loan being no longer than the term of the lease and no longer than a term of a senior financing of the real estate.

81. The method of claim 77:
wherein ownership of the real estate and of a lease of the real estate being are arranged in one or more special-purpose entities bankruptcy remote from obligations unrelated to the real estate; and
the lockbox is structured to isolate payment risk to the credit of the tenant;
an interest rate on the junior loan being based on the credit of the tenant.

82. The method of claim 77, wherein:
the junior loan is collateralized at least in part by a junior assignment of rents under the lease in lieu of a mortgage foreclosable by the junior lender against the real estate, the junior assignment being junior to any assignment of rents to the senior lender.

83. The method of claim 77, wherein:
payments to the junior lender are guaranteed by a credit default swap arranged to cover default of the tenant on rents under the lease.

84. A method, comprising the steps of:
advancing a junior loan of funds from a junior lender to a owner of an interest in real estate, the junior loan being subordinate to a senior financing of the real estate, the junior loan being collateralized by a pledge to the junior lender of rent cash flows generated by a lease of the real estate or of the ownership of the owner, the terms of the junior loan being non-recourse against the real estate, the owner and lessor of the real estate, or a tenant of the real estate except at most bad boy acts and force majeur events;
at least one step of originating, managing or servicing the junior loan being performed with the assistance of a computer.

85. The method of claim 84, wherein:
the junior lender has a guarantee of payment either under a bond-type lease or under a derivative contract providing equivalent guarantee of payment.

86. The method of claim 84, a term of the junior loan being no longer than the term of the lease and no longer than the term of a senior financing of the real estate.

87. A method, comprising the steps of:
advancing a junior loan of funds from a junior lender to a owner of an interest in real estate, the junior loan having a payment priority that is senior to all other obligations of the owner except a senior financing, the junior loan being collateralized by a pledge to the junior lender of rent cash flows generated by a lease of the real estate, terms of the junior loan being non-recourse against the real estate, the owner, or a tenant of the real estate except at most bad boy acts and force majeur events;
at least one step of originating, managing or servicing the junior loan being performed with the assistance of a computer.

88. The method of claim 87, wherein:
the junior lender has a guarantee of payment either under a bond-type lease or under a derivative contract providing equivalent guarantee of payment.

89. The method of claim 87, a term of the junior loan being no longer than the term of the lease and no longer than the term of the senior financing.

90. A method, comprising the steps of:
lending funds to create a junior loan from a junior lender to a owner of real estate, the real estate being under lease from the owner to a tenant, the junior loan being subordinate to a senior financing owed by the owner, the junior loan being independent of the senior financing, an interest rate of the junior loan being based on the credit of the tenant;
at least one step of originating, managing or servicing the loan being performed with the assistance of a computer.

91. The method of claim 90, the owner having surrendered over to a lockbox arrangement the right to rents paid by a tenant under the lease, the lockbox being obligated to make a senior payment to a senior lender of the senior financing and a junior payment to the junior lender before the owner receives any residual of the lease payments.

92. The method of claim 90, wherein:
the lease imposes bond-type payment obligations on the tenant.

93. The method of claim 90, further comprising the step of:
entering a derivative contract providing the junior lender a guarantee of payment equivalent to a bond-type lease.

94. The method of claim 93, a term of the junior loan being no longer than the term of the lease and no longer than the term of the senior financing.

95. The method of claim 90, a term of the junior loan being no longer than the term of the lease and no longer than the term of the senior financing.

96. The method of claim 90:
ownership of the real estate and of a lease of the real estate being arranged in one or more special-purpose entities bankruptcy remote from obligations unrelated to the real estate.

97. The method of claim 90, wherein:
the junior loan is collateralized at least in part by a junior assignment of rents under the lease, the junior assignment being junior to any assignment of rents to the senior lender.

98. The method of claim 90, wherein:
payments to the junior lender are guaranteed by a financial derivative arranged to cover default of the tenant on rents under the lease.

99. The method of claim 98, wherein:
the financial derivative is a credit default swap.

100. The method of claim 90, wherein:
the junior loan is collateralized by a pledge to the junior lender of rent cash flows generated by a lease of the real estate, in lieu of a pledge of or a lien over the real estate nor against any ownership interest in any entity with an ownership interest in the real estate, except at most in the event of bad boy acts and force majeur events.

101. The method of claim 90, wherein:
the junior loan is collateralized by a pledge to the junior lender of rent cash flows generated by a lease of the real estate, the terms of the junior loan being non-recourse against the real estate, the lessor of the lease, or a tenant of the real estate, except at most in the event of bad boy acts and force majeur events.

102. The method of claim 90, the junior loan having a payment priority that is senior to all other obligations of the owner except a senior financing, terms of the loan being non-recourse against the real estate, the owner, or a tenant of the real estate except at most bad boy acts and force majeur events.

103. The method of claim 90, wherein:
the junior loan is advanced after the senior financing.

104. The method of claim 90, wherein:
the junior loan is advanced contemporaneously with the senior financing.

105. The method of claim 90, wherein:
the terms of the junior loan have the effect of imposing requirements on the tenant in event the tenant enters bankruptcy and reaffirms the lease.

106. The method of claim 90, wherein:
the terms of the lease obligate the tenant to continue to pay rent in the case of at least a partial condemnation taking, and terms of the loan provide recovery to the junior lender against any recovery by tenant or landlord for the condemnation.

107. The method of claim 90, further comprising the step of:
the junior lender issuing obligations backed by the payments from the lockbox arrangement.

108. The method of claim 107, wherein:
the obligations include a private placement participating or syndicating the loan.

109. The method of claim 107, wherein:
the obligations include a publicly-issued security.

110. The method of claim 107, further comprising the step of:
reserving at least part of the junior payment for an over-collateralization account for the protection of the obligations.

111. A method, comprising the steps of:
receiving a payment on a junior loan:
the junior loan being secured by payments under a lease of an asset, either the lease providing a bond-type guarantee of payment of rents under the lease or the lease being enhanced with a bond-equivalent financial guarantee of payment;
ownership of the asset and of a lease of the asset being arranged in one or more special-purpose entities (SPE's) bankruptcy remote from obligations unrelated to the asset, the owner SPE owing a senior financing to a senior lender and the junior loan to the junior lender;
the owner SPE having surrendered over to a lockbox arrangement the right to rents paid by a lessee under the lease, the lockbox being obligated to make a senior payment to the senior lender and a junior payment to the junior lender before the owner SPE receives any residual of the lease payments; and
at least one step of originating, managing or servicing the junior loan having been performed with the assistance of a computer.

112. The method of claim 111, wherein:
the asset is commercial real estate.

113. The method of claim 112, wherein:
the junior loan is collateralized at least in part by an assignment of rents under the lease junior to any assignment to the senior lender.

114. The method of claim 112 wherein:
the lease is a bond-type lease.

115. The method of claim 112 wherein:
the lease is a double-net or triple-net lease.

116. The method of claim 115 wherein:
payments to the junior lender are guaranteed by a financial derivative arranged to cover default of the tenant on rents under the lease.

117. The method of claim 116, wherein:
the financial derivative is a credit default swap.

118. The method of claim 115, wherein:
payments to the junior lender a guaranteed by a financial derivative arranged to cover conditions that relieve the tenant of an obligation to pay rent.

119. The method of claim 118, wherein:
the financial derivative is a covenant of an advance from a servicer to cover expenses in relieving the condition, in turn secured by a cash reserve.

120. The method of claim 119, wherein:
the cash reserve is the property of the junior lender, and reverts to the junior lender on full repayment of the junior loan.

121. The method of claim 112, wherein:
payments to the junior lender are guaranteed by a financial derivative arranged to cover default of the tenant on rents under the lease.

120. The method of claim 121, wherein:
the financial derivative is a credit default swap.

121. The method of claim 112, wherein:
the junior loan is collateralized by a pledge to the junior lender of rent cash flows generated by a lease of the real estate, in lieu of a pledge of or a lien over the real estate nor against any ownership interest in any entity with an ownership interest in the real estate, except at most in the event of bad boy acts and force majeur events.

124. The method of claim 112, wherein:
the lockbox arrangement includes two different servicers or custodians of different depository accounts for servicing the junior loan and senior financing, respectively.

125. The method of claim 112, wherein:
a single servicer makes the payments to the senior and junior lenders from a single depository account.

126. The method of claim 112, wherein:
the lockbox arrangement further makes a payment for operating expenses or taxes before the owner receives any residual of the lease payments.

127. The method of claim 112, wherein:
the junior loan was advanced after the senior financing.

128. The method of claim 112, wherein:
the junior loan was advanced contemporaneously with the senior financing.

129. The method of claim 112, wherein:
the terms of the junior loan have the effect of imposing requirements on the tenant in event the tenant enters bankruptcy and reaffirms the lease.

130. The method of claim 112, wherein:
the terms of the lease obligate the tenant to continue to pay rent in the case of at least a partial condemnation taking, and terms of the loan provide recovery to the junior lender against any recovery by tenant or landlord for the condemnation.

131. The method of claim 112, wherein:
the asset is a single-tenant property.

132. The method of claim 112, wherein:
the asset is a multi-tenant property, and the owner has surrendered over to a lockbox arrangement the right to rents paid by several tenants of the real estate.

133. The method of claim 112, further comprising the step of:
the junior lender issuing obligations backed by the payments from the lockbox arrangement.

134. The method of claim 133, wherein:
the obligations include a private placement participating or syndicating the loan.

135. The method of claim 133, wherein:
the obligations include a publicly-issued security.

136. The method of claim 133, further comprising the step of:
reserving at least part of the junior payment for an over-collateralization account for the protection of the obligations.

137. The method of claim 112, wherein:
the owner has covenanted under the terms of the junior loan, in the event of default by the tenant, to surrender rents under any replacement lease to the lockbox arrangement.

138. The method of claim 112:
a term of the junior loan being no longer than the term of the lease and no longer than the term of a senior financing of the asset;

139. A method, comprising the steps of:
advancing a junior loan of funds from a junior lender to an owner of an interest in real estate, the junior loan being subordinate to a senior financing of the real estate:
the junior loan being secured by payments under a lease of an asset, either the lease providing a bond-type guarantee of payment of rents under the lease or the lease being enhanced with a bond-equivalent financial guarantee of payment;
ownership of the asset and of a lease of the asset being arranged in one or more special-purpose entities (SPE's) bankruptcy remote from obligations unrelated to the asset, the owner SPE owing a senior financing to a senior lender and the junior loan to the junior lender;
a term of the junior loan being no longer than the term of the lease and no longer than the term of the senior financing;
the owner SPE surrendering over to a lockbox arrangement the right to rents paid by a lessee under the lease, the lockbox being obligated to make a senior payment to the senior lender and a junior payment to the junior lender before the owner SPE receives any residual of the lease payments; and
performing at least one step of originating, managing or servicing the junior loan with the assistance of a computer.

140. The method of claim 139, wherein:
the terms of the junior loan are non-recourse against the real estate, the lessor of the lease, or a tenant of the real estate, except at most in the event of bad boy acts and force majeur events.

141. The method of claim 139, the junior loan having a payment priority that is senior to all other obligations of the owner except the senior financing, terms of the loan being non-recourse against the real estate, the owner, or a tenant of the real estate except at most bad boy acts and force majeur events.

142. The method of claim 139, wherein:
an interest rate of the junior loan is based on the credit of the tenant.
